(19) United States
(12) Patent Application Publication
(10) Pub. No.: US 2024/0401655 A1
(43) Pub. Date: Dec. 5, 2024

(54) APPARATUS FOR FACILITATING SERVICING OF VEHICLE BRAKE ASSEMBLIES

(71) Applicant: Workplace Maintenance Solutions Pty Ltd, Riddells Creek (AU)

(72) Inventor: Allan Martin JAMES, Riddells Creek (AU)

(73) Assignee: Workplace Maintenance Solutions Pty Ltd, Riddells Creek (AU)

(21) Appl. No.: 18/688,996

(22) PCT Filed: Jun. 11, 2021
(86) PCT No.: PCT/AU2021/050600

§ 371 Date: Mar. 4, 2024

Related U.S. Application Data
(60) Provisional application No. 62/705,103, filed on Jun. 11, 2020.
(60) Provisional application No. 63/176,913, filed on Apr. 20, 2021.

(51) Int. Cl. F16D 65/00; B66F 7/26

(52) U.S. Cl. CPC F16D 65/0043; B66F 7/26; F16D 2250/0084

(57) ABSTRACT

Disclosed herein is an apparatus for facilitating assembly and/or dis-assembly of a vehicle brake assembly, the apparatus being configured to be positionable relative to the brake assembly and movable away from the vehicle and further being configurable to support and hold a selected part of the vehicle brake assembly for facilitating removal and installation thereof, and wherein the apparatus comprises a positioning assembly configured to controllably move the selected held part of the brake assembly relative to a base of the apparatus, and the positioning assembly is further configured to raise and lower the held selected part between a lowered position where the selected part is in contact with or on the ground and a raised position where the selected part and adaptor assembly is transportable by the apparatus to or from the vehicle.

### FIELD OF THE INVENTION

This invention relates to an apparatus for facilitating removal and servicing of a vehicle brake assembly and in particular heavy vehicle brake assemblies such as those used on buses and trucks and the like.

### BACKGROUND OF THE INVENTION

Inspection, removal and servicing of vehicle brake assemblies is awkward and time consuming due to the significant weight of the components comprising such vehicle brake assemblies. Heavy vehicle brake assemblies such as those for trucks and buses are even more cumbersome and where a drum can weigh in excess of 65 kg, each dual set of wheels can weigh about 130 kg and a hub assembly can weigh in excess of 50 kg. The general awkwardness and weight of these assemblies, for example a truck wheel with tyre is over a metre in diameter, can introduce substantial health and safety risks and therefore typically requires the presence of multiple technicians to conform to current legislated regulations. Multiple technicians thus increases the time and cost due to the manual labour required.

Furthermore while there are current methods for supporting one of the components of a heavy brake assembly and which are beneficial for removal and installation of that one particular component, assistance is still lacking in many areas of the brake assembly process and therefore technicians are still involved in risky manual handling in many stages of the removal, maintenance and installation process. Typically each apparatus is only suitable for use with only a single component. No single apparatus can deal with multiple components of the heavy brake assembly or even components of different brake types, such as calipers and drums, thereby requiring many pieces of equipment for dealing with the entire brake maintenance process or still requiring manual handling for at least part of the maintenance.

Furthermore, it is difficult to pick-up heavy components such as drum, caliper or hub and rotor assembly which have been placed on the ground, due to the mechanical limitations of those prior art apparatus. And thus manual handling is still required to pick up off the ground heavy brake assembly parts when replacing damaged with new components or after components have been maintained which presents significant risk to the service technicians.

Moreover, storage of the heavy assembly parts once they have been removed is messy and takes up room. There are also associated risks of storing wheels and other cylindrical parts on their cylindrical surfaces where they may move or roll to other locations. Otherwise if they are stored on their flat surfaces, they are extremely difficult to move from the ground due to their significant weight.

Aligning of the brake assembly parts is also difficult, particularly for re-installation, and the speed of this often depends on the skill of the technician. Furthermore if the load exceeds 350 kg, initiating movement of a trolley or other wheeled apparatus can expose the technician to injuries and is also largely inaccurate and therefore time-consuming.

Furthermore calipers are generally mounted to one side of the rotor in heavy brake assemblies. In preparation for removal, the service technician typically rotates the rotor such that caliper is positioned above the rotor in a balanced and stationary position. When unbolting the caliper there is still a risk that the caliper can become unbalanced and fall off the vehicle, so that the technician must stabilise the heavy caliper with one hand while unbolting which is a dangerous and awkward process.

Previous apparatus for facilitating servicing of a caliper have disadvantageously only allowed removal of the caliper when it is balanced at the top of the rotor due to the movement of the caliper by action of gravity. Removal of the caliper when it was located at any other position other than at the top of the rotor is therefore difficult or near impossible.

Lastly, there is little or no non-manual procedures available for removal of drive or stub axles. Particularly in the case of stub axles, two maintenance technicians are required, one to hold the stub axle and the other to rotate the stub axle, and therefore this is an awkward process which can present significant risk of injury to the technicians, and further is time-consuming.

Examples of the invention seek to solve or at least ameliorate one or more disadvantages of previous methods or apparatus for facilitating assembly and dis-assembly of brake assemblies which reduces the risk to technicians by elimination of manual handling, eases the difficulty of aligning for assembly and dis-assembly, or reduces the time taken or costs for these procedures.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to an aspect of the present invention there is provided an apparatus for facilitating assembly and/or dis-assembly of a vehicle brake assembly, the apparatus being configured to be positionable relative to the brake assembly and movable away from the vehicle and further being configurable to support and hold a selected part of the vehicle brake assembly for facilitating removal and installation thereof, and wherein the apparatus comprises a positioning assembly configured to controllably move the selected held part of the brake assembly relative to a base of the apparatus, and the positioning assembly is further configured to raise and lower the held selected part between a lowered position where the selected part is in contact with or on the ground and a raised position where the selected part and adaptor assembly is transportable by the apparatus to or from the vehicle.

The selected part can be a drum or a hub and rotor assembly.

The drum and/or hub and rotor adaptor assembly can be further configured to supportably hold and to pivot said brake drum or hub and rotor assembly and when so held, the brake drum or hub and rotor assembly can be pivotable from an operative position where the held drum or hub and rotor assembly has a longitudinal axis which is generally horizontal to a transverse position wherein the axis is generally vertical.

The apparatus is configured to rotate the brake drum or a hub and rotor assembly from a position which facilitates removal and installation from the vehicle and to another position such that an exposed portion of the brake drum or a hub and rotor assembly faces the ground and to lower the brake drum or a hub and rotor assembly until the exposed portion is on or in contact with the ground.

The positioning assembly can be configured to controllably move the selected held part of the brake assembly in two transverse directions in a horizontal and/or a vertical plane for facilitating removal and installation.

Preferably the positioning assembly has at least one actuating means for driving the controllable motion, wherein the actuating means is an electric linear actuator.

Preferably, the positioning assembly has a sighting means for aiding a user to align the selected part when in an operative position relative to the vehicle for aiding removal and installation of the selected part.

According to an embodiment the apparatus further comprises a holding assembly configured to engage and hold a selected adaptor assembly, the selected adaptor assembly configured so as to be able to support and hold the selected part of the vehicle brake assembly, the holding assembly also being configured to dis-engage and hold the selected adaptor assembly and to engage and hold a further selected adaptor assembly which is configured to hold a further selected part different to the first, and wherein the holding assembly is configured to supportably hold either of the selected adaptor assemblies and respective held selected part for transport between an in-situ position and a removed position to facilitate removal and installation of the selected part or further part.

According to another aspect of the present invention there is provided an apparatus for facilitating assembly and/or dis-assembly of a vehicle brake assembly, the apparatus being configured to be positionable relative to the brake assembly and movable away from the vehicle and further being selectably configurable to support and hold a selected part of the vehicle brake assembly for facilitating removal and installation thereof, the apparatus comprising a holding assembly configured to engage and hold a selected adaptor assembly, the selected adaptor assembly configured so as to be able to support and hold a selected part of the vehicle brake assembly, the holding assembly also being configured to dis-engage and hold the selected adaptor assembly and to engage and hold a further selected adaptor assembly which is configured to hold a further selected part different to the first, and wherein the holding assembly is configured to supportably hold either of the selected adaptor assemblies and respective held selected part for transport between an in-situ position and a removed position to facilitate removal and installation of the selected part or further part.

The selected part or parts can include one or more of the following: hub, rotor, drum, caliper, wheel, stub axle and/or drive axle. Preferably, the selected part is a brake drum or a hub and rotor assembly and the selected adaptor assembly is configurable to selectively hold a brake drum or hub and rotor assembly.

When the drum and/or hub and rotor adaptor assembly is further configured to supportably hold and to pivot said brake drum or hub and rotor assembly and when so held, the brake drum or hub and rotor assembly can be pivotable from an operative position where the held drum or hub and rotor assembly has a longitudinal axis which is generally horizontal to a transverse position wherein the axis is generally vertical. Preferably, the configuration for selectively holding a brake drum includes attachment of a cradle assembly for supporting a bell of the drum.

Preferably, one of the selected parts is a caliper and the selected adaptor assembly is configured to support and carry a caliper.

Preferably, one of the selected parts is a vehicle wheel or a dual set of wheels and the selected adaptor assembly is a rack configured to carry an upright vehicle wheel or a dual set of spaced-apart upright wheels thereon. More preferably, the rack has a pair of arms, each arm extending from opposite edges of the base which movable between a position where they clamp about the rim of the wheel for facilitating the upright configuration of the wheel and a position which facilitates rolling of the wheel(s) from the rack.

In another embodiment, the selected part is a stub axle or a drive axle and the selected adaptor assembly is a stub axle adaptor assembly or a drive axle adaptor assembly configured to supportably hold the stub axle or drive axle and wherein the stub axle or drive axle adaptor assembly is further configured to be removably attachable to the drum and/or hub and rotor adaptor assembly.

The apparatus can comprise a positioning assembly configured to controllably move the selected held part of the brake assembly relative to a base of the apparatus, and the positioning assembly is further configured to raise and lower the selected adaptor assembly and held selected part between a lowered position where the selected part is in contact with or on the ground and is dis-engageable from the corresponding adaptor assembly for storage and a raised position where the selected part and adaptor assembly is transportable by the apparatus to or from the vehicle.

In yet another aspect of the present invention there is provided an apparatus for facilitating assembly and/or dis-assembly of a vehicle brake assembly, the apparatus being configured to be positionable relative to the brake assembly and movable away from the vehicle and further being selectably configurable to support and hold an engaged hub and rotor assembly for facilitating removal and installation thereof, wherein the apparatus has a separating assembly having at least two expandable devices receivable in a cavity formed by the hub and rotor assembly, and when the separating assembly is so received, the expandable devices are drivable into an expandable configuration for forcible separation of the hub and rotor assembly.

In a further aspect of the present invention there is provided a system for facilitating assembly or dis-assembly of a brake assembly having an apparatus according to any one of claims and including at least one selectable adaptor assembly which is configurable to engage to support and hold a selected part or parts of the vehicle brake assembly for facilitating removal and installation thereof wherein the selected part or parts include one or more of the following: hub, rotor, drum, caliper, wheel, stub axle and/or drive axle; and any two or more afore-mentioned selected parts when so engaged.

Preferably, the selected part is a hub and rotor assembly and the selected adaptor assembly held by the apparatus is configured for holding a hub and rotor assembly and wherein the system includes a trolley having a separating assembly having at least two expandable devices receivable in a cavity formed by the hub and rotor assembly, and when the separating assembly is so received, the expandable devices are drivable into an expandable configuration for forcible separation of the hub and rotor assembly.

According to a further aspect of the present invention there is provided a method of facilitating dis-assembly of parts of a vehicle brake assembly using the apparatus as described above having a selected adaptor assembly, including the steps of: configuring the selected adaptor assembly to supportably engage a selected part of the brake assembly: engaging the configured selected adaptor assembly for supporting the selected part at the vehicle: removing the selected part from the vehicle: dis-engaging the selected part for storage; then dis-engaging the selected adaptor assembly; and repeating above steps for a further selected part, wherein the selected parts are removed in the following general order: wheels; caliper: drum or rotor and hub assembly: drive axle; and stub axle. Preferably the steps are carried out in substantially the reverse order for assembly of the vehicle brake assembly.

### BRIEF DESCRIPTION OF THE DRAWINGS

The present invention will now be described, by way of non-limiting example, with reference to the accompanying drawings in which:

FIG. 1 is a perspective view of an apparatus configured for lifting and/or moving and carrying parts of a heavy brake assembly according to another embodiment of the present invention;

FIGS. 2 and 3 are front views of the apparatus of FIG. 1 where in FIG. 4 a rear view shows a portion of the apparatus cutaway to show actuating means;

FIGS. 5, 6 and 7 are various enlarged views of the apparatus of FIGS. 1 to 4;

FIG. 8 is a view of system having an apparatus of FIGS. 1 to 7 with an adaptor assembly configured for carrying a hub and rotor assembly;

FIGS. 9 and 10 are views of the apparatus showing the hub and rotor assembly rotated 90° from its position in FIG. 12;

FIGS. 11 and 12 are perspective views of the adaptor assembly of FIGS. 8 to 10 without and with the rotor and hub assembly respectively:

FIGS. 13 and 14 are top perspective views of a system for forcibly separating the rotor and hub assembly so held in FIGS. 11 and 12;

FIGS. 15 and 16 are side views of a pulling device for pulling a rotor and hub assembly from an axle;

FIGS. 17, 18 and 19 are perspective views of the system and apparatus of FIGS. 1 to 7 having an adaptor assembly configured to facilitate servicing of a stub axle;

FIG. 20 is a perspective view of the apparatus of FIG. 1 having an adaptor assembly configured to facilitate servicing of the drive axle;

FIG. 21 is a perspective view of the adaptor of FIG. 20 configured to facilitate servicing of a drive axle;

FIGS. 22 and 23 are views of an adaptor assembly configured to allow the apparatus of FIG. 1 to facilitate servicing of the drum of a heavy brake assembly without and with a drum respectively:

FIG. 24 is a view of the apparatus including the adaptor assembly of FIGS. 22 and 23 showing lowering of the drum onto the ground;

FIGS. 25, 26 and 27 are perspective views of the system with the apparatus of FIGS. 1 to 7 carrying a rack with a pair of wheels;

FIG. 28 is a view of the apparatus of FIGS. 25, 26 and 27 carrying wheels and a drum engaged thereto;

FIGS. 29 and 30 are views of the rack for holding a pair of wheels;

FIG. 31 is an isolated view of a rotating device of FIG. 31 for rotating the wheels when held on a rack;

FIG. 32 is a rack for holding a pair of wheels having the rotating device of FIG. 31 according to another preferred embodiment of the present invention;

FIG. 33 is an enlarged view of a portion of the rack of FIG. 32;

FIGS. 34 and 35 are views of an apparatus having a hydraulic system according to an alternative embodiment of the present invention;

FIG. 36 is a view of an apparatus including the adaptor assembly configured to carry a caliper;

FIG. 37 is the adaptor assembly shown in FIG. 36;

FIG. 38 is the adaptor assembly of FIG. 37 shown in exploded form;

FIG. 39 is a rear perspective view of an apparatus for lifting and/or moving and carrying parts of a heavy brake assembly and including a separation assembly forcible separation of the hub and rotor;

FIGS. 40 and 41 are rear and side perspective reviews respectively of the apparatus of FIG. 39 with the separating assembly is open and closed;

FIGS. 42 and 43 are top views of the separating assembly of FIGS. 40 and 41 in isolation for the purposes of illustration;

FIG. 44 is a rear perspective view of the separating assembly of FIGS. 42 and 43;

FIG. 45 is a side view of an arm of the separating assembly; and

FIG. 46 is an enlarged view of a thrust bearing assembly of FIG. 45:

FIG. 47 is a rear perspective view of an alternative embodiment of an apparatus for removing and installing a heavy brake assembly:

FIG. 48 is a view of the apparatus of FIG. 47 preparing for removal of an in-situ caliper:

FIG. 49 is a view of the apparatus of FIGS. 47 and 48 engaging with the in-situ caliper:

FIG. 50 is a view of the apparatus of FIGS. 47 to 49 having engaged with the removed caliper:

FIG. 51 is a view of the apparatus of FIGS. 47 to 50 depositing the engaged caliper on the ground:

FIG. 52 is a view of the apparatus of FIGS. 47 to 51 having the removed caliper on a support trolley:

FIGS. 53 and 54 are views of an alternative adaptor assembly carrying a drum in horizontal and vertical axis orientations; and

FIG. 55 is a view of the adaptor assembly of FIGS. 53 and 54 held by the apparatus for removing and installing a heavy brake assembly.

### DETAILED DESCRIPTION OF THE INVENTION

Preferred features of the present invention will now be described with particular reference to the accompanying drawings. However, it is to be understood that the features illustrated in and described with reference to the drawings are not to be construed as limiting on the scope of the invention.

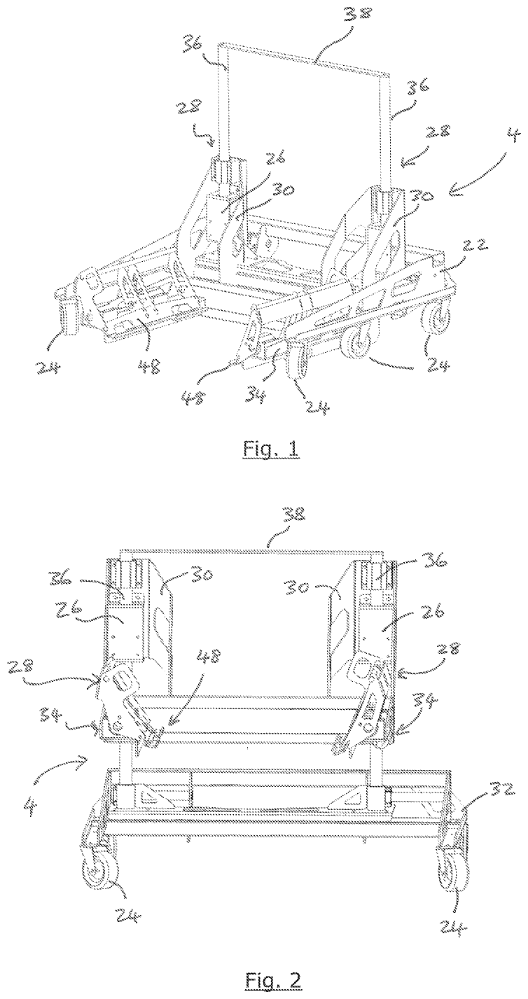

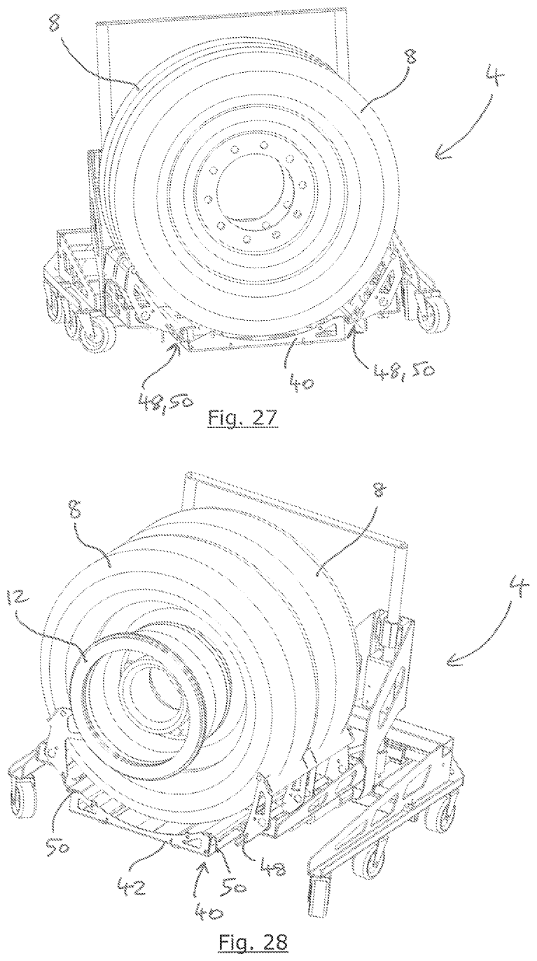

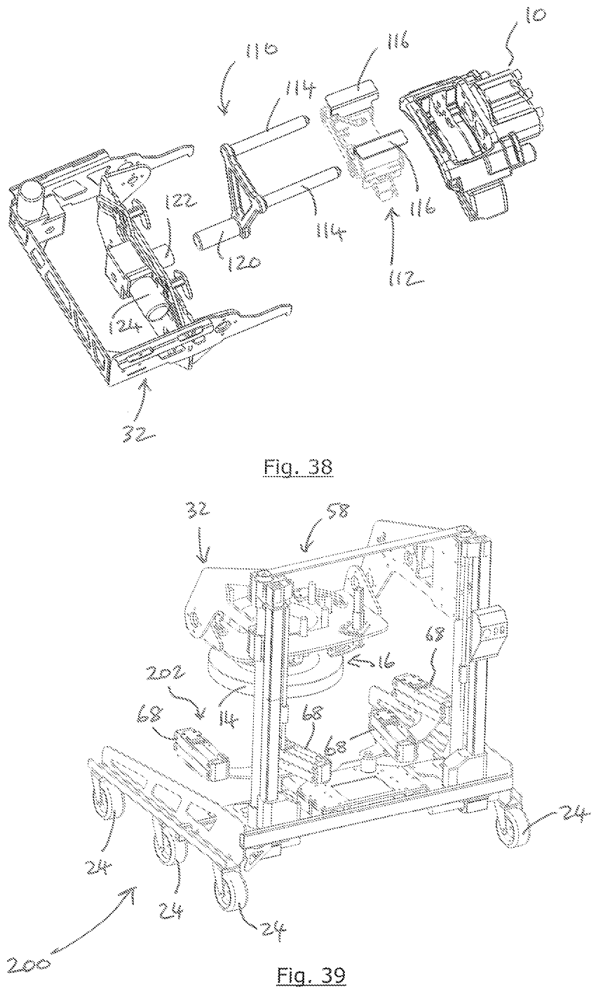

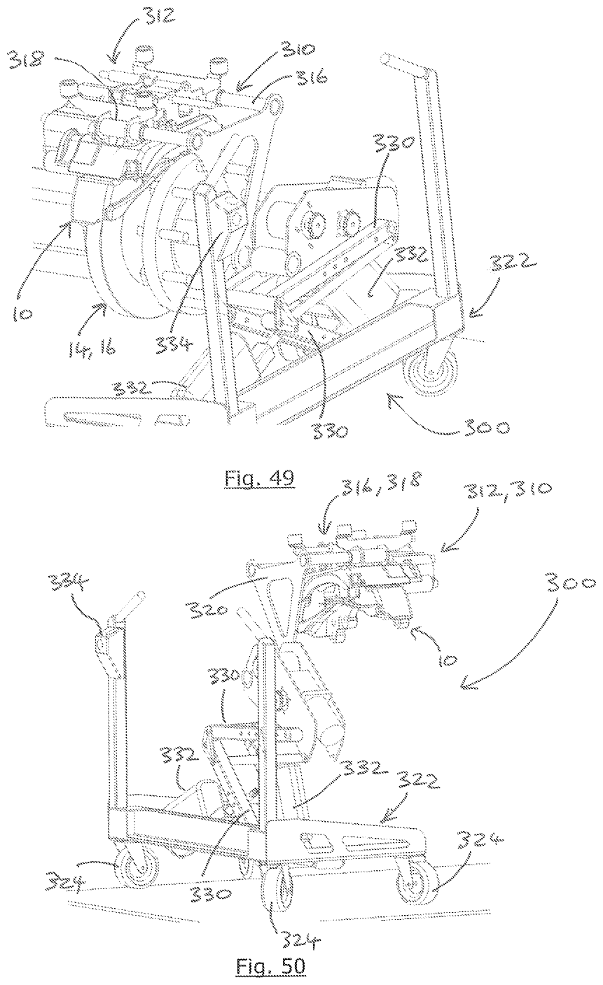

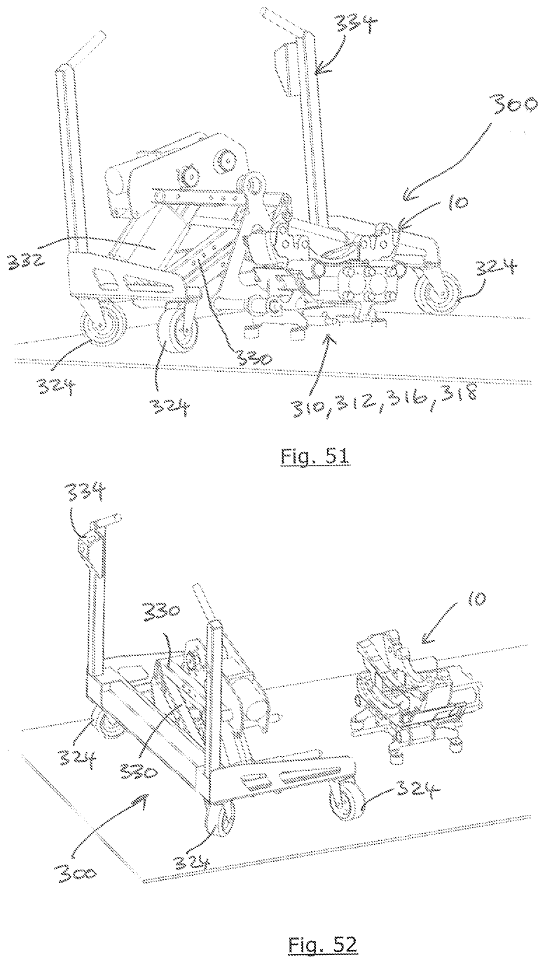

FIGS. 1 to 55 are views of a system 2 and apparatus 4, 6, 200, 300 for facilitating servicing of a heavy vehicle brake assembly according to preferred embodiments of the present invention. In particular the apparatus 4, 6, 200, 300 and system 2 are configured to support the heavy brake assembly or at least one component thereof for removal, maintenance and installation or re-installation. The apparatus 4, 6, 200, 300 is positionable to and from the heavy brake assembly for facilitating removal and installation of at least one selected component, and preferably all the components sequentially, of the heavy brake assembly including wheels 8, caliper 10, drum 12, rotor 14 and hub 16, stub axle 18 and drive axle 20. The apparatus 4, 200, 300 is supported by a base 22 which is held above the ground by a set of rollers, for instance, as shown in FIG. 1 the base has a set of six caster wheels 24.

Although in the embodiments there is illustrated the system 2 and apparatus 4, 6, 200, 300 shown for use in heavy vehicle brake assemblies such as those used in trucks and buses it would be understood that the present invention could equally be used for other brake assemblies in other vehicles including personal road vehicles and the like.

The apparatus 4, 200, 300 is also configured to move a held component or components relative to the base 22 of the apparatus 4 so as to provide fine adjustment in position to more easily and conveniently align the component or components so held. Preferably, the apparatus 4, 200, 300 is configured to be able to enable fine positioning movement in three orthogonal directions, in particular parallel or lateral to the axle of the heavy brake assembly when the apparatus 4 is in in-situ. Although the apparatus 4, 6 is positionable relative to the heavy brake assembly by moving the whole apparatus 4, 6 on rollers this typically results in poor accuracy and is highly dependent on the skill of the technician involved. Furthermore fine positioning of the held component(s) of the apparatus 4 is more difficult when moving the apparatus 4, 6 on wheels and carries additional health and safety risks, especially when initiating movement of a heavy load exceeding 350 kg, such as a load comprising a pair of heavy vehicle wheels with a drum 12 attached as illustrated in FIG. 28.

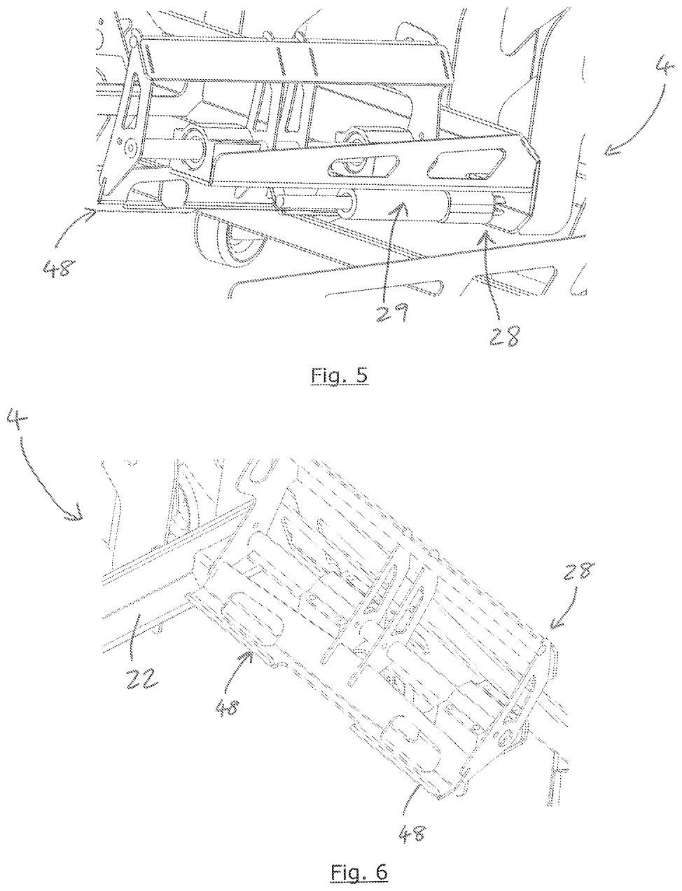

As illustrated in the embodiment of FIGS. 1 to 7, the apparatus 4 has a positioning assembly for moving a component when in an operative position relative to the axis of the heavy brake assembly generally in at least two directions, preferably three directions, which are orthogonal to each other. In particular the positioning assembly moves the component(s) held relative to the base of the apparatus 4 once the apparatus 4 has been initially positioned close to the heavy brake assembly via the wheels 24. The positioning assembly thus allows for movement, preferably fine movement, of the holding assembly and the component(s) so held for aligning the component easily with the axle or other parts of the heavy brake assembly which assists in removing and re-installing of the components. In this preferred embodiment, the positioning assembly can move the holding assembly in at least one or more directions relative to the axis of the axle of the heavy brake assembly, for example, in any of the three directions parallel to or lateral to the axle, i.e. raise and lower along a vertical axis (FIGS. 1, 8 and 25 to 27), forward and backwards parallel to the axle (FIGS. 5 and 6), and side-to-side in a lateral direction to the axle (FIGS. 2 to 4).

The positioning assembly includes a lifting assembly which can raise and lower the holding assembly and any selected component the holding assembly is carrying or holding, which can be via a respective selected adaptor assembly. The lifting assembly has a pair of lifting devices which lifts and lowers the holding assembly in a vertical line. Each lifting device comprises actuating means, in particular electric linear actuators 26 for driving the lifting and lowering which allows precise control over the movement of the holding assembly to raise and lower the component(s) so held thereby, especially when the base of the apparatus 4 is fixed so as to be stationary.

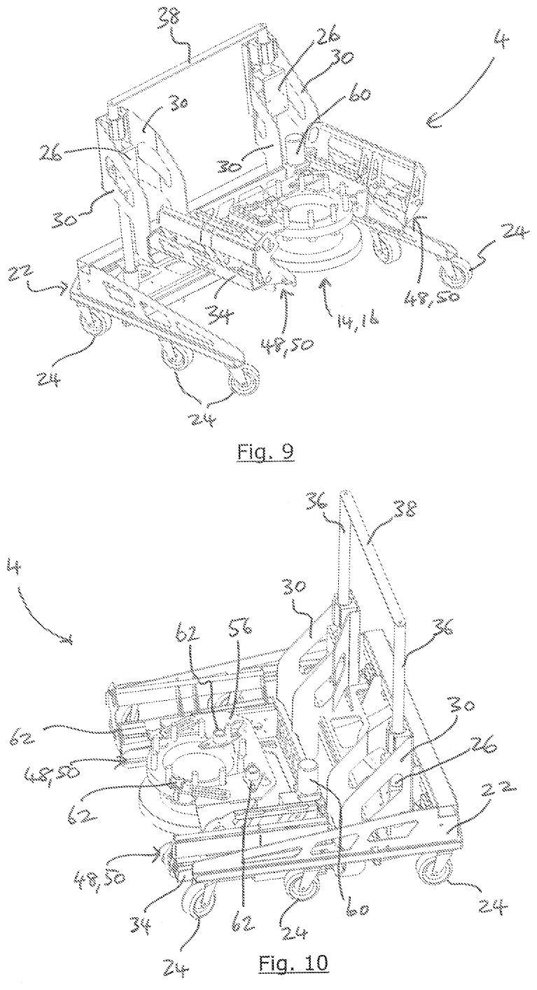

The lifting assembly is also configured such that it is able to raise and lower the holding assembly and any held selected component in the selected adaptor assembly through a range of about 1 m in height. In particular, the lifting assembly is able to lower the holding assembly at its lowest point such that the held selected component can be deposited on the ground and detached for storage. Similarly, the lifting assembly can lower the holding assembly to the ground such that any selected component held in its adaptor assembly can picked up from the ground by attachment to the holding assembly for installation to heavy vehicle or removal elsewhere for maintenance. In the example illustrated in FIG. 9, the holding assembly can carry the rotor and hub assembly 14 in its adaptor assembly 32, in an upper position which is suitable for removal from or installation to the heavy vehicle, and in FIG. 10 the rotor and hub assembly 14, 16 in its adaptor assembly 32 can be lowered to the ground for storage or maintenance.

The lifting assembly has a pair of arms 28 which project downwardly so that the end portions of the arms 28 on which the arms 28 are connected extend past the base 22 therefore allowing the components held in respective adaptor assemblies 32 to be lowered to ground level. In this embodiment, each arm 28 comprises a pair of vertical flanges 30 having the linear actuator 26 therebetween to house the linear actuator 26. Each arm 28 also has an elongated horizontal portion 34 on which the selected adaptor assembly for holding a selected brake assembly part is supportably held.

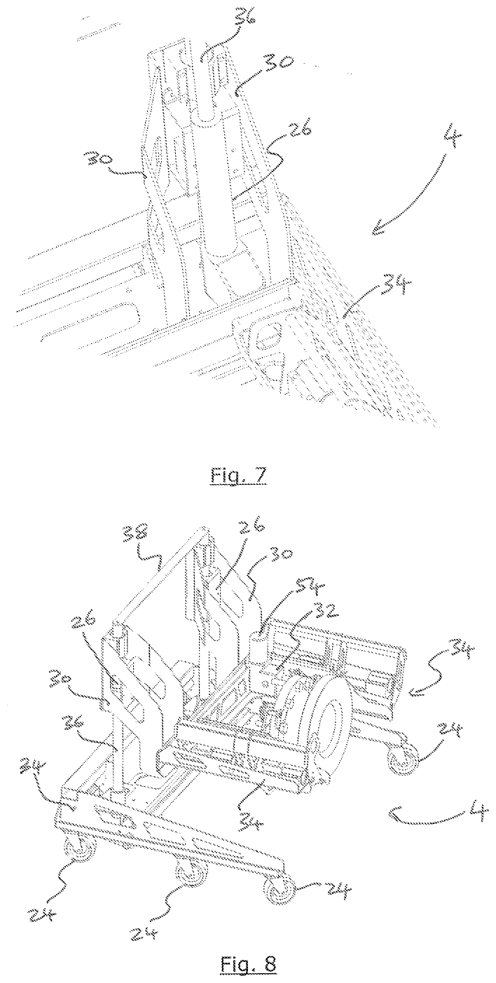

FIG. 7 is a bottom view of the lifting assembly which illustrates the actuating means which is shown in this example as linear actuators, 26 which is able to be controlled so as to move the holding assembly between the raised and lowered positions and to accurately and controllably halt the elevation of the holding assembly and held selected component(s) in its adaptor assembly at any position therebetween. The linear actuators 26, one on each side of the lifting assembly, raise and lower the holding assembly along a pair of vertical shafts 36. The vertical shafts 36 are joined at their upper ends by a bar 38 which can then serve as a handle for moving the apparatus 4.

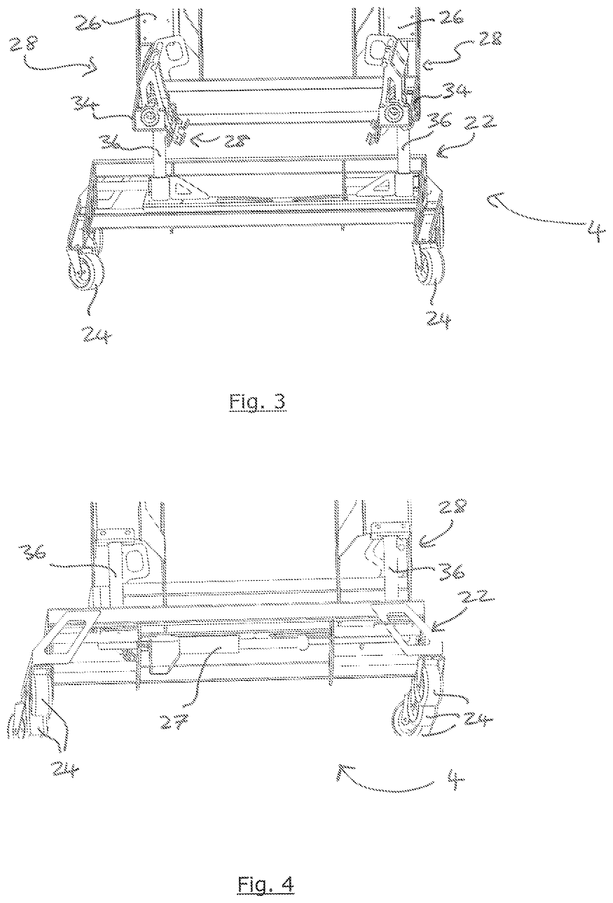

The positioning assembly can also include moving assemblies which can move the holding assembly (and any selected component(s) in their respective adaptor assembly) lateral to the vertical axis, for example forward and rearward movement, and/or side to side movement (FIGS. 2 to 4). In particular, FIG. 2 shows the apparatus 4 having the lifting assembly including the holding assembly in a left-most position while FIGS. 3 and 4 show the apparatus 4 show the lifting assembly including the holding assembly in a right-most position. A rear wall of the apparatus 4 has been cutaway in FIG. 4 to show actuating means, for example a linear actuator 27, which is able to be controlled so as to move the holding assembly between the left-most and right-most positions and to accurately and controllably halt the holding assembly (and held selected component(s) in their respective adaptor assembly) at any position therebetween.

Alternatively or additionally, the apparatus 4 can be configured to move the holding assembly forward and rearward, or when the apparatus 4 is positioned in-situ at the brake assembly, the holding assembly (and any selected component so held in its respective adaptor assembly) is movable parallel to the wheel axle. As illustrated in FIGS. 5 and 6, the apparatus 4 is configured such that the holding assembly including the upwardly projecting lip portions 48 is controllably movable relative to horizontal portions 34 of the arms of the lifting assembly thereby providing forward and rearward movement of the holding assembly and any selected component held in its respective adaptor assembly via actuating means. Preferably, the actuating means is in the form of linear actuators 29, one on each arm which work in tandem to move the holding assembly forward and rearward.

Actuating means, such as those in the form of linear actuators 26, 27, 29 have multiple advantages over the use of hydraulic cylinders. The force delivered by hydraulics is significantly heavier and more robust and to lift the two sides of the lifting assembly the output delivered to the hydraulic cylinders has to be split to enact an even lift: this requires multiple cylinders with associated housing and controls. As typically hydraulic cylinders work in a disproportionate sense, for example in this context, when there are two cylinders acting together the cylinder with the least load would advance further. To compensate for this uneven movement the mechanism has to be built more strongly with output often sacrificed to extend movement. For example, if one metre of lift is required and the cylinder has a 400 mm working range then then a ratio of 3 to 1 is needed.

Therefore to lift 100 kg to a maximum of 1 metre would require 300 kg output from the cylinders and to account for the weight of the mechanisms itself, an additional 200 kg to compensate for the additional cylinder output. As the load is added to the mechanical weight then the cylinder needs to apply 500 kg to lift just 100 kg to a maximum of 1 metre. The mechanism required to do this adds to the weight of the apparatus itself so that the total load is now 550 kg and the overall weight and size can represent a health and safety risk when maneuvering. Typically the hydraulic mechanism may have to be accommodated at the rear of the apparatus so as to be able to be manipulable into the space available under or about a brake assembly, particularly a heavy brake assembly and such this can shift the centre of mass of the apparatus and the load so carried dangerously forward of the front wheels of the apparatus.

In comparison the actuating means comprising two (or multiples of two) linear actuators 26 are easily programmable to advance vertically and equally in parallel, and, if one fails they can be programmed to both stop or limit movement thereby avoiding uneven raising and lifting of the lifting assembly. This actuating arrangement is also able to compensate for the load and its own weight and therefore the same mechanism needed to lift 200 kg would only need to be rated to 200 kg lift not 350 kg as required if using hydraulic cylinders. Thus the total load of the apparatus and any components so held being maneuvered by the technicians is about 400 kg thereby reducing health and safety risks. Further it is easier to ensure that the centre of mass and load is closer to the centre of mass of the apparatus alone thereby enabling easier manipulation of the apparatus 4 by the technicians.

The apparatus 4 can also include a power drive (not shown in the FIGS.) which includes an electric motor thereby allowing the wheels to be driven so that little effort is required from the technicians. In a preferred embodiment, the motor can drive at least one pair of wheels 24 for ease of moving the apparatus 4 especially when heavily loaded, for example carrying a pair of heavy vehicle wheels 8 and the drum 12 which would be about 200 kg. For convenience of use, the motor can be directable by a control stick which is able to be manipulated by the technician to drive the apparatus 4 in any desired direction without effort and thereby avoiding or reducing health and safety issues.

In particular this system 2 and apparatus 4 are configurable such that the one apparatus can be configured to engage and/or hold a selected one or more of the components of the heavy brake assembly. In particular, the apparatus 4 has a holding assembly for holding an adaptor assembly which can hold one or more selected components. Thus the apparatus 4 can be configured to support the afore-mentioned first selected component of the heavy brake assembly while it is being removed from an in-situ position on the heavy brake assembly to a removed position away from the heavy brake assembly for storage, disposal and/or maintenance. Once the afore-mentioned selected component is no longer held or disengaged from the apparatus 4, and then the apparatus is reconfigurable to engage or hold a second selected component of the heavy brake assembly different to the first component. These steps are then repeated until the entire heavy brake assembly has been dismantled, preferably piece-by-piece, and removed from the vehicle and the process followed in reverse to re-install the heavy brake assembly.

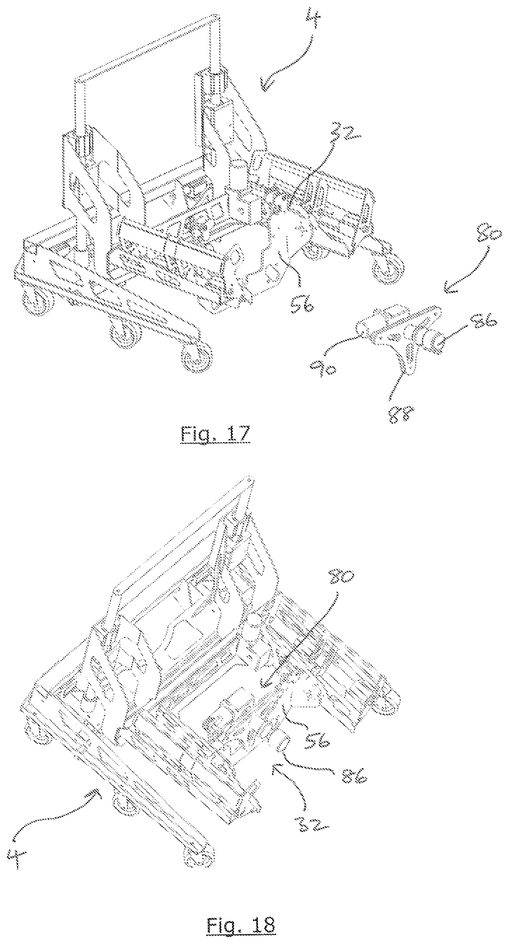

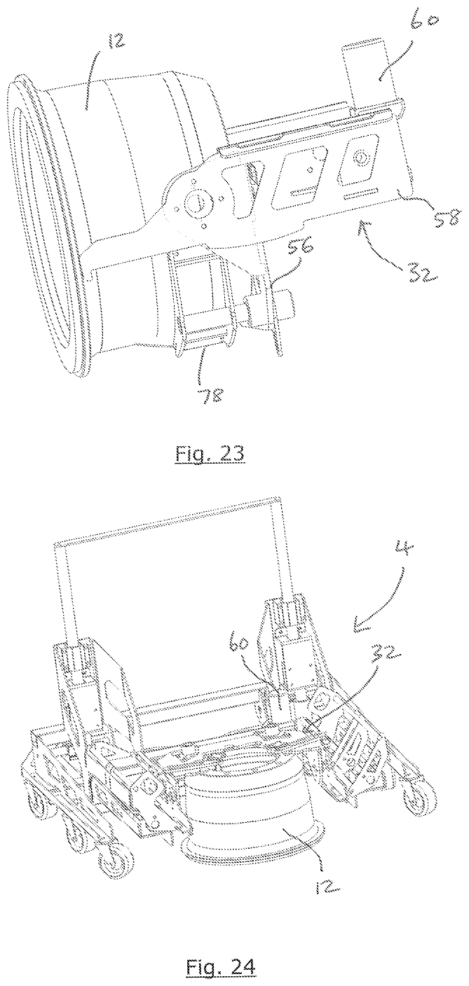

As illustrated in the example of FIGS. 8 to 14, the apparatus 4 is configured to support a rotor and hub assembly 14, 16. The apparatus 4 can also be configured to hold and/or engage with an accessible part of the stub axle 18 or drive axle 20 as shown in FIGS. 17 to 21 for removal to a remote position as required for the heavy vehicle brake assembly maintenance. The apparatus 4 can then be reconfigured to carry a drum 12 as illustrated in the example of FIGS. 22 and 24. As illustrated in the example of FIGS. 25 to 28, the apparatus 4 is then configurable to carry a rack 40 on which a pair of heavy vehicle wheels 8 are being supported in an upright position. Further, in FIG. 28, the apparatus 4 can carry the wheels 8 with the drum 12 still attached. Further details of the abilities of the apparatus 4 to hold and/or support a selected component when desired will described in the following paragraphs.

Therefore advantageously the system 2 and apparatus 4, 6 is configurable to engageably support or hold all components of the heavy brake assembly, at least one selected part at a time, for support, removal and storage. Then the system 2 and apparatus 4 is then configurable to support or hold another selected component of the heavy brake assembly until all the components of the heavy vehicle brake assembly are completely removed from the heavy vehicle for performing any required maintenance or repair and then to re-install the heavy vehicle brake assembly in reverse order component by component using the same apparatus. Thus only one system 2 or apparatus 4 is required for the entire process of brake assembly removal, maintenance, repair and reinstallation advantageously saving time, labour and storage costs.

Former apparatus for supporting and holding the components of the heavy brake assembly were only configured for a single component such as the drum or caliper removal and therefore multiple apparatus were required to do a complete brake assembly removal and re-installation. None of these apparatus were able to remove, support or install stub axles, drive axles nor wheels with the drum attached. If an apparatus was able to engage and position two components, one of components would be only poorly accommodated.

Furthermore, the current flexibility of the apparatus is its ability to accommodate differences in usage in different jurisdictions and possible changes in future usage. In the United States, 90% of heavy vehicles use drum brakes, and is expected to increase usage of disc brakes while in Europe the heavy vehicles there substantially use disc brakes. Thus, the applicant can reduce manufacturing costs by being able to manufacture substantially the same apparatus which can accommodate both types of brakes with little or no modification or with purchase of specific adaptor assemblies depending on need.

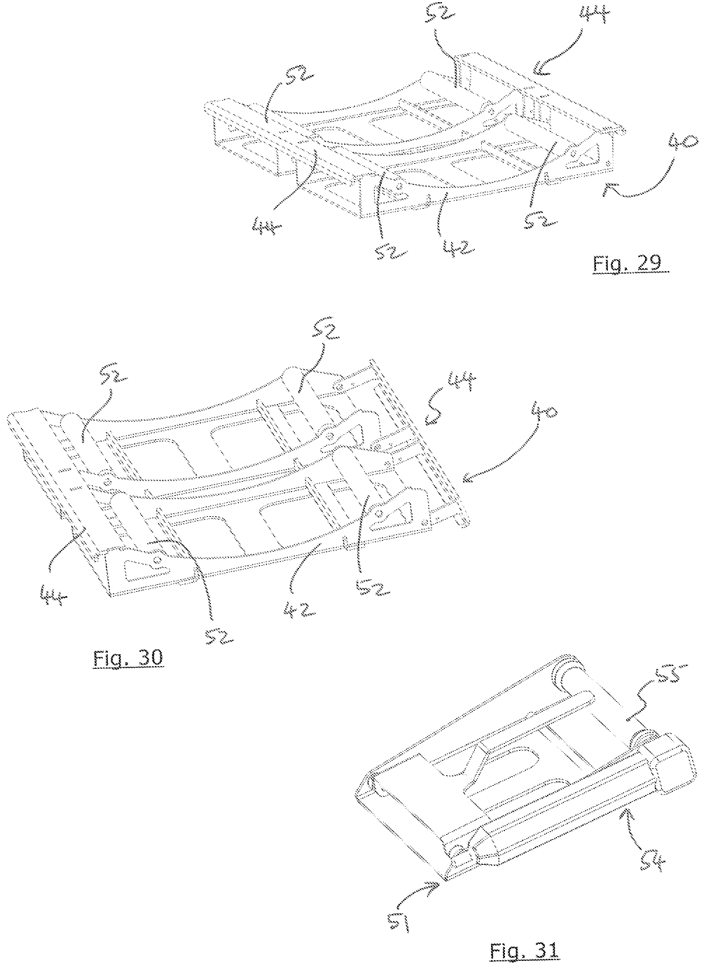

Typically the first step in maintenance of a heavy brake assembly is removal of the wheels 8. As illustrated in FIGS. 25 to 33, the apparatus 4 is configured to hold a pair of heavy vehicle wheels in a parallel spaced-apart configuration in which they are typically held on the heavy vehicle itself. Therefore the apparatus is configured to supportably hold a selected wheel adaptor assembly in the form of a rack 40 on which the wheels 8 can be carried. The empty rack 40 as shown in FIG. 29 can be in a configuration which allows it to be picked up by the apparatus 4 and when the apparatus 4 is positioned such that the rack 40 is located under the dual set of wheels, the rack 40 can receive the rim of the wheels 8 thereon in the parallel spaced-apart configuration and holds them stably and upright in that configuration.

The rack 40 has a base 42 for supporting the wheels 8 and two pairs of arms 44 pivotally connected on opposing sides of the base 42. The arms 44 are pivotally movable between an open configuration, as illustrated in FIG. 30, in which the wheel or wheels 8 can be rolled or decanted off the rack if desired and a holding configuration illustrated in FIG. 29 in which the wheels 8 are stably held in the spaced-apart upright configuration. The arms 44 can have biasing means which bias the arms 44 in the holding configuration such that each pair of arms 44 clamp about one of the wheels 8 to hold it therebetween stably. The biasing means can be in the form of a spring 46. As shown in FIGS. 29 and 30, the arms 44 can be attached together to move in tandem although the rack 40 could be configured such that they can be separably movable.

The two pairs of arms 44 of the rack 40 are also configured to be supportably engageable with the apparatus 4, 6 so that the apparatus 4, 6 can lift and/or otherwise position the rack when so engaged. In particular, the horizontal portions 34 of the arms 38 of the holding assembly have upwardly projecting lip portions 48 on an inner edge thereof which are configured to mateably interengage with downwardly projecting lip portions 50 on the outer edges of the arms 44 of the rack 40.

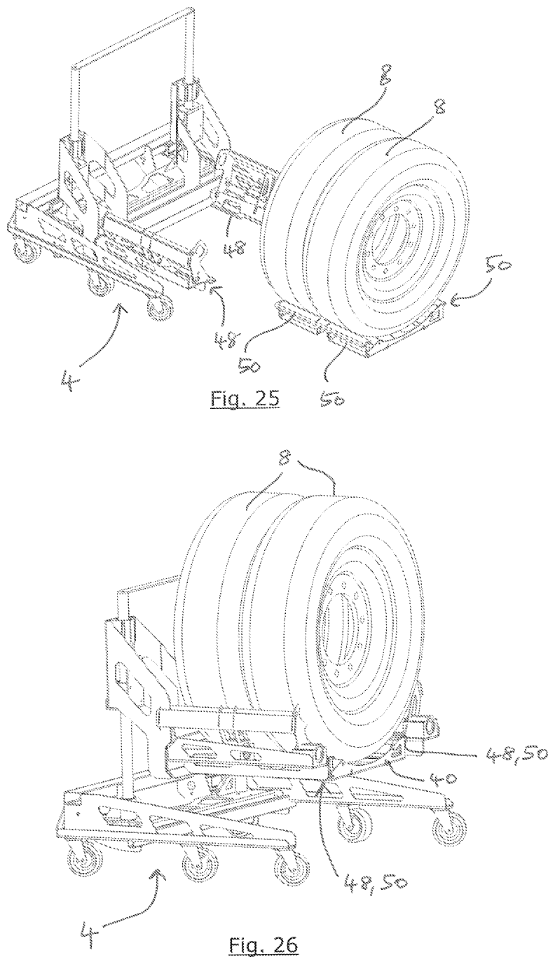

Once the wheels 8 have been un-bolted from the heavy vehicle, the wheels 8 can thus be safely and easily removed therefrom and to a location for storing the wheels. The apparatus 4 can then lower the rack 40 to the floor for storage while still in the upright stable spaced-apart configuration. In this way, all the wheels 8, say 16 wheels for a Double-B truck trailer, can be removed in one step, positioned remote from the heavy vehicle as shown in FIG. 26, lowered to the ground where each dual set of wheels is stored on its own rack as shown in FIG. 25, and then stored neatly and sequentially without risk of rolling and injury to the maintenance technicians. Advantageously, the stud-hole alignment of the dual set of wheels 8 is maintained from removal to storage to re-installation which eases the process of removal and installation of the wheels 8.

The rack 8 can also include two pairs of rollers 52 on which the rim of the wheels is supported on the base 42, each wheel 8 supported on one pair of rollers 52. Thus when the rack 40 is stored on the ground and the arms 44 are in the open configuration, the rollers 52 allow the wheels 8 to be rotated for inspection where the wheels 8 are rotated by hand. The wheels 8 can thus be rotated when in storage when the racks 40 are on the ground or when they are supported by the apparatus 4 in-situ at the heavy vehicle for removal and installation. Furthermore the rack 40 can include a rotating device 53 which is configured to drivably rotate the wheels. The rotating device 53 can be in the form of an electric motor 54 which is configured to drive the roller 52 to assist in rotating of the wheel 8 as illustrated in the embodiment of FIGS. 31 to 33. In the preferred embodiment, the rotating device 53 drives rotation of the wheel 8 when the rack 40 is in the open configuration. The rotating device 53 is preferably attachable to the rack 40 when rotation of the wheel 8 is desired although it could be understood that the device 53 can be incorporated into the rack 40 in a more permanent arrangement if necessary.

The next step after the wheels 8 have been removed, if the brake type is a disc brake, is typically removal of the caliper 10 then the rotor and hub assembly 14, 16.

The apparatus 4 can be configured to selectably hold the rotor and hub assembly 14, 16 and to manipulate the held rotor and hub assembly 14, 16 in any of three orthogonal directions relative to the base 22 via the positioning assembly as described above to facilitate easy removal as illustrated in FIGS. 8 to 10. Furthermore, the apparatus 4 is also configured to be able to rotate the rotor and hub assembly 14, 16 in a forward and backward direction such that the rotor and hub assembly 14, 16 can be rotated between an upright position where an axis of the rotor and hub assembly 14, 16 is generally horizontal (FIG. 8) and a horizontal position where the axis is generally vertical (FIGS. 9 and 10).

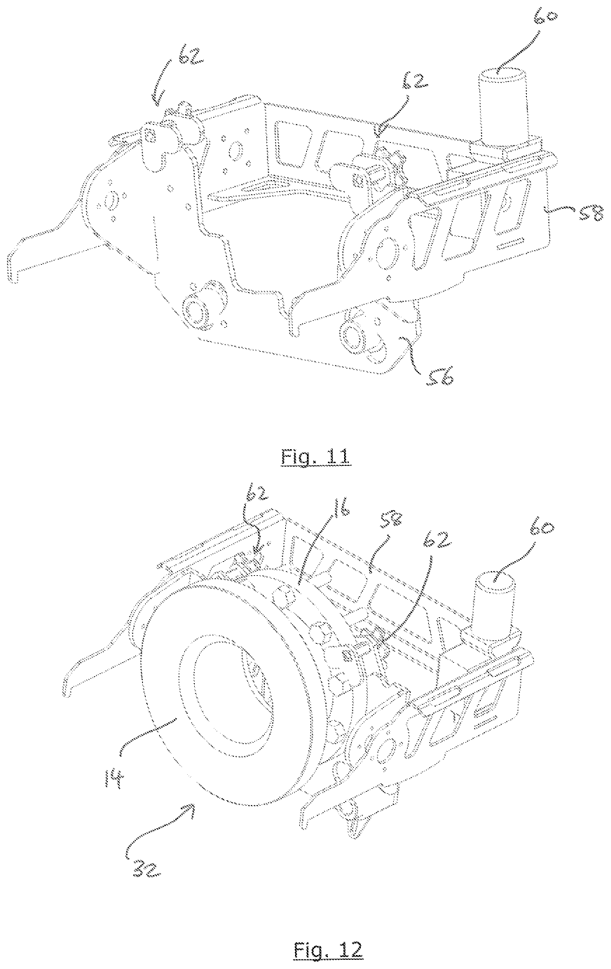

The apparatus 4 can be selectably configured to hold the rotor and hub assembly 14, 16 by an adaptor assembly 32 which has an adaptor plate 56 which extends between two arms of a support frame 58 and is pivotally supported thereto as exemplified in FIGS. 11 and 12. Therefore the adaptor plate 56 with the attached rotor and hub assembly 14, 16 can be pivoted backwards and forwards as required.

The opposing sides of the support frame 58 have downwardly projecting lip portions 50 which are adapted to mateably inter-engage with corresponding upwardly projecting lip portions 48 of the arms 28 of the holding assembly. In particular the apparatus 4 can be lowered and moved such that lip portions 48 of the apparatus are aligned underneath the respective lip portions 50 of the support frame and then raised slightly for inter-engagement. To pick up any selected component the steps are reversed. This inter-engagement operates similarly to the way the rack 40 for supporting wheels 8 is supported by the apparatus 4 as described above. The adaptor plate 56 is pivotally supported between support frame arms and is configured to engageably receive the hub 16, in particular, at least one wheel stud can be received in a corresponding slot or notch in the plate 56 to secure it. The pivoting of the adaptor plate 56 and thus any engaged hub and rotor assembly 14, 16 can be operated by an electric motor 60 which can be controlled remotely by from a central control panel on the apparatus 4 or wirelessly away from the apparatus 4. Alternatively the adaptor plate 56 can be manually manipulated for rotation of the hub and rotor assembly 14, 16.

To ensure the hub and rotor assembly 14, 16 is held fixably to the adaptor plate 56 especially once it has been pivoted to the horizontal position one or more clamping members 62 can be used to clamp the hub 16 to an upper portion of the adaptor plate 56. In the preferred embodiment four clamping members 62 are used to engage or hold the hub 16. In the horizontal position, the held rotor and hub assembly 14, 16 can then lowered to the ground for storage on an exposed position of the held rotor and hub assembly 14, 16 which faces the ground. Alternatively the holding assembly can be lowered so as to be able to receive and engage a rotor and hub assembly 14, 16 from the ground and then raise the held rotor and hub assembly 14, 16 and move it to the heavy brake assembly for installation.

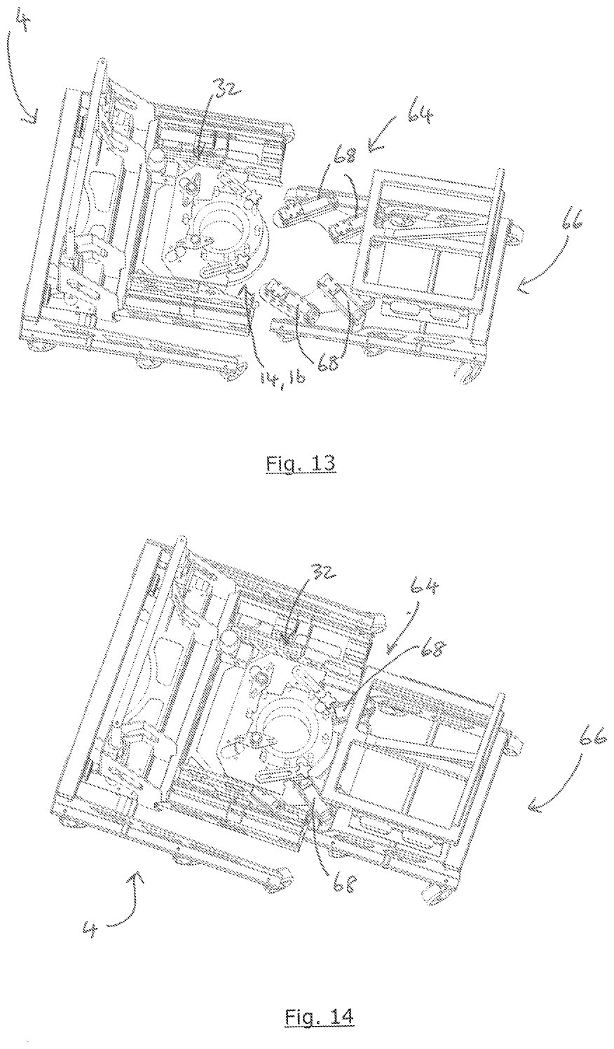

Alternatively, while the apparatus 4 is holding the rotor and hub assembly 14, 16 in the horizontal position, a separating assembly 64 as illustrated in FIG. 13, can be used to forcibly separate the rotor and hub 14, 16 which are often seized or bound together by corrosion. The separating assembly 64 can be positionable, so as to be able to be inserted into a circumferential cavity defined by the internal opposing surfaces of the hub and rotor assembly 14, 16 and then removed once separated. In particular, the separating assembly 64 can be mounted on a frame which is supported from the ground by a set of rollers, such as castor wheels, for example in the form of a trolley 66, to facilitate the positioning of the separating assembly 64 to and away from the hub and rotor assembly 14, 16.

The support trolley 66 can also be configured to carry any of the selected adaptor assemblies 32, 40, 78, 80, 92 so as to be easily at hand and further can carry a hydraulic pump (not shown) for supplying any hydraulic systems such as used on the puller or a pneumatic rotator for rotating the roller 55 on the wheel rack or on another preferred apparatus as described below.

The separating assembly 64 can comprise four expandable devices 68 which are, when positioned for operation as illustrated in FIG. 14, configured to be distributed substantially evenly and circumferentially about the hub/rotor axis within the circumferential cavity. Preferably four expandable devices 68 can be used as shown in the example of FIGS. 13 and 14, although it could be understood that three or five or more devices 68 could be arranged for similar effect. The devices 68 are arranged to be connected so as to operate simultaneously and to expand at the same rate for effective forcible separation of the hub and rotor 14, 16 however the devices 68 could be arranged to operate independently if necessary. The four expandable devices 68, working together, provide the oppositely directed forces, preferably up to 40 tonnes of force, required to forcibly push two components 14, 16 apart. For example, the expandable devices 68 may operate by at least one actuating means each, for example a hydraulic system where a hydraulic pump may be connected via connectors to all four devices, each having a hydraulic cylinder, and which are easily connectable and dis-connectable for portability. When separated, the hub 16 will be retained on the apparatus 4 as it is clamped thereto and the rotor 14 will fall or rest on the ground.

Each of the expandable devices 68 has a jaw assembly having a pair of jaws which are configured to be received in the circumferential cavity defined by the opposed surfaces of the hub and rotor 14, 16. The jaw assembly has two elongate members, the ends of which are pivotally connected side-by-side to an end member. The pivotal connections between the elongate members and the end member have parallel pivotal axes such that the opposite ends of the elongate members can pivotally move toward and away from one another and thereby define the pair of jaws. The opposite end of each elongate member supports a bearing member, pivotally coupled to the respective elongate member. The axes of the pivotal couplings are parallel to the axes of pivotal connections.

The expandable device has actuating means for driving the jaws from a contracted configuration in which the elongate members are close to parallel to an expanded configuration in which the two bearing members are increased in separation. The actuating means includes a linear actuator located between the elongate members which may be a pneumatic, electrical or hydraulically powered system.

In use, in the contracted configuration the bearing members of the jaws can be inserted in the cavity defined by the opposed surfaces. Once received in the cavity, the jaws can then be expanded into the expanded configuration such that the outwardly directed surfaces of the bearing members engage with the inwardly opposed surfaces to exert oppositely directed forces thereon to push the opposed surfaces apart. In operation a wedge-shaped separating member is forced between the bearing members by action of the linear actuator, wherein the angled surfaces of the separating member slide along the inwardly angled surfaces of the bearing members thereby driving the jaws open, In other words, force is transmitted by the linear actuator from the end member to the separating member and the angled surfaces of the separating member acting on the bearing members translates the force into expansion of the jaws to provide the oppositely directed forces required to push two components apart. The device may include one or more biasing springs (not seen in the drawings) to urge the jaws toward the contracted configuration against the action of the separating member.

In a more preferred embodiment of the present invention illustrated in FIGS. 39 to 46, there is also provided an apparatus 200 which is configured to have the functional capabilities of both the apparatus 4 and the support trolley 66 as described in the paragraphs above. In particular, the apparatus 200 is configured to be able to able to allow safe and easy removal of the engaged hub and rotor 14, 16 from the axle of a heavy vehicle. Once removed the apparatus 200 also has a separating assembly 202 which is configured to separate the hub and rotor 14, 16 safely as will be discussed in more detail in the following paragraphs. Advantageously, the apparatus 200 does not require a separate support trolley 66 for carrying and positioning the separating assembly 64 and thus the disengagement of the hub and rotor 14, 16 can be performed more efficiently and without removal of the engaged hub and rotor 14, 16 from the apparatus 200.

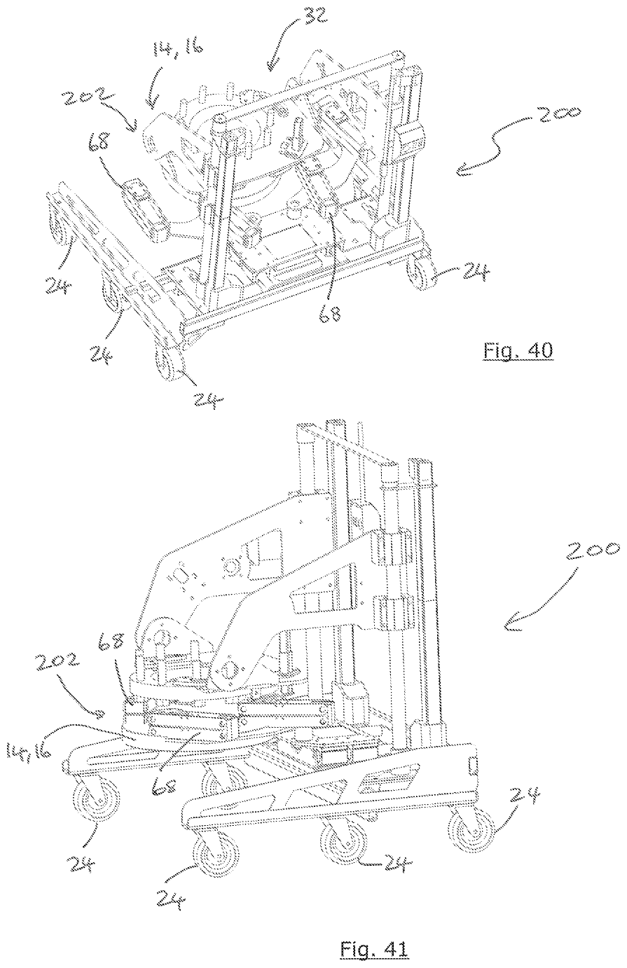

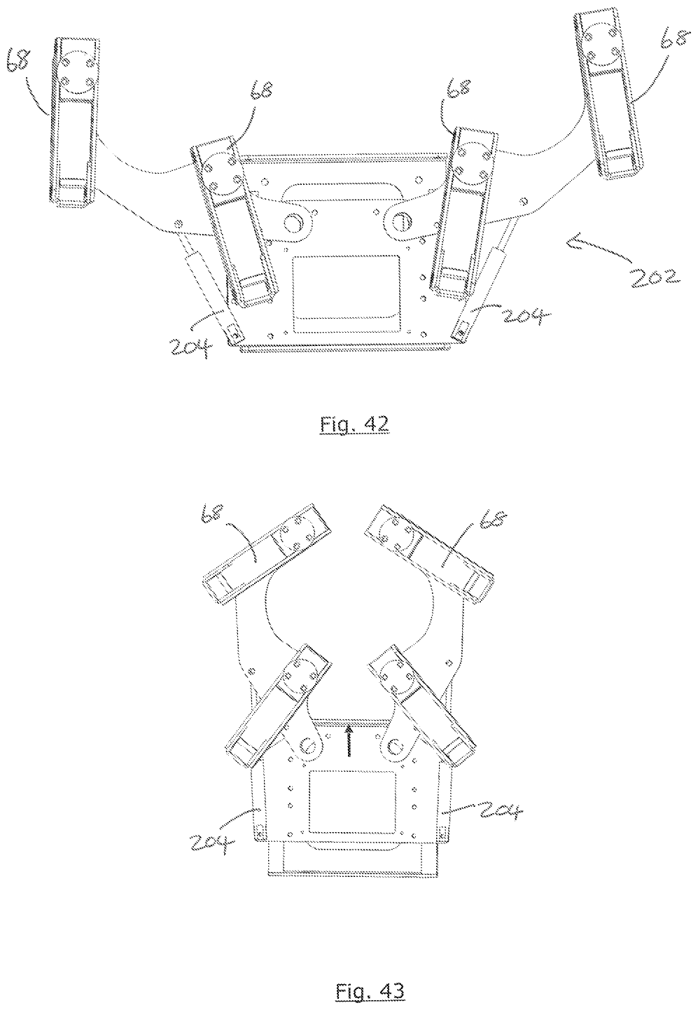

As illustrated more particularly in FIGS. 40 to 46, the separating assembly 202 operates similarly to the separating assembly 64 however it has been configured so that apparatus 200 is also able to remove and install the engaged hub and rotor assembly 14, 16 without interference from the separating assembly 202. In particular, the separating assembly 202 is supported from the base of the apparatus 200 and is able to move between two positions: one position where the separating assembly 202 is retracted such that the apparatus 200 can remove, install and/or otherwise manipulate the engaged hub (FIGS. 40 and 42) and rotor and another position where the separating assembly 202 can be received within a cavity of the engaged hub and rotor 14, 16 for separation thereof (FIGS. 41 and 43).

The apparatus 200 is configured such that the separating assembly 202 is slidably movable forward and backward with respect to the rear of the apparatus 200. As the separating assembly 202 moves forward (as shown by the arrow in FIG. 43), the separating assembly 202 has a pair of arms, each of which carry a pair of spaced-apart expandable devices 68 which are configured to pivot pincer-like inwardly so as to be received in the engaged hub and rotor as illustrated in FIG. 42. As described above, the four expandable devices 68, working together, provide the oppositely directed forces, preferably up to 40 tonnes of force, required to forcibly push the hub and rotor 14, 16 apart. The separating assembly 202 then retracts rearwardly once the hub and rotor are separated and the arms pivot outwardly so that any further installation, removal or manipulation of the hub and/or rotor 14, 16, drum, caliper or other component can be conducted without interference from the separating assembly 202. Notably, the separating assembly 202 must be retracted rearwardly into a dormant position otherwise the arms, in the open configuration without being retracted, would extend beyond the width of the base of the apparatus 200. Such a condition where the arms extend beyond the base would be both unsafe, unsightly, generally inconvenient as well as interfere with normal operation.

The arms and slidable movement of the separating assembly 202 is driven by a driving system preferably comprising driving cylinders, for example pneumatic or hydraulic cylinders 204 although other driving systems can be used: two cylinders driving the slidable movement and one cylinder driving each of the pivoting of the arms. Biasing members, in the form of springs 206 as shown in the example of FIG. 44, urge the retraction of the separating assembly 202 rearwardly and pivoting of the arms into the open positions once the driving force from the cylinders has been released.

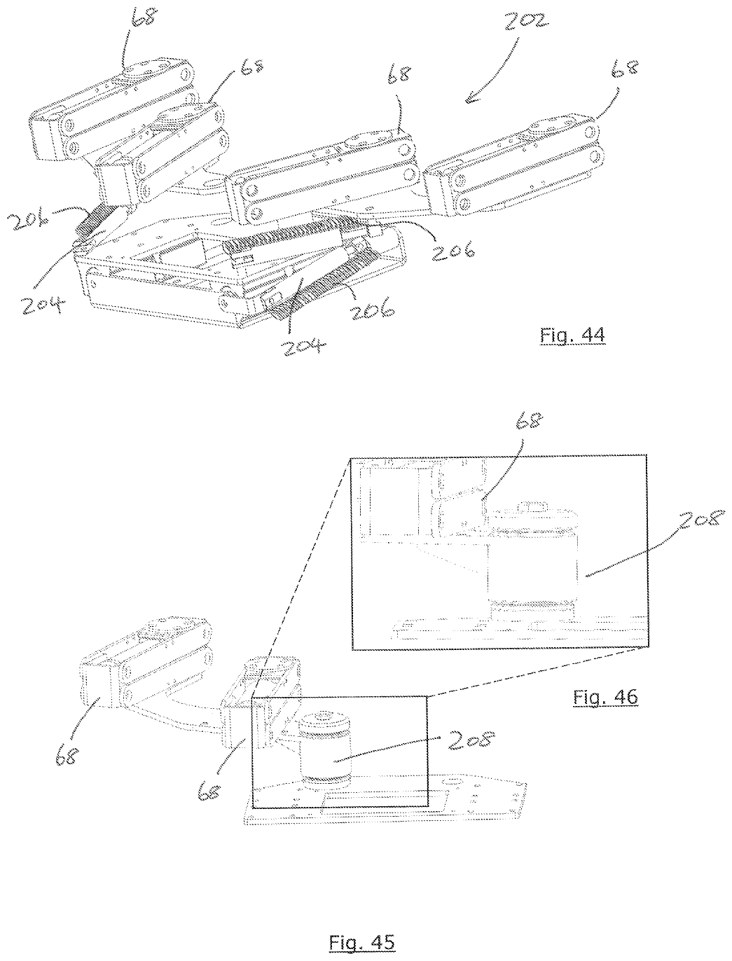

In a particularly preferred embodiment of the invention illustrated in FIGS. 45 and 46, each of the arms of the separating assembly are supported by a thrust bearing assembly 208 which assists to be able to bear the tonnes of forces necessary to forcibly separate the engaged hub and rotor and yet allow pivoting motion of the arms.

The separation process is preferably automated so that an operator can commence the process, and walk away while the separation progress, this is to prevent any injury to the operator as the engaged hub and rotor can break apart catastrophically during separation therefore presents a safety hazard. Thus a preferred example method for separation of the engaged hub and rotor using the apparatus 202 by the following steps: the operator activates a switch to commence the process and steps away to a safe distance away from the apparatus 200; the apparatus 202 rotates the hub and rotor 14, 16 into a horizontal position such that the axis of the hub and rotor is vertical with the rotor bottom-most; the hub and rotor 14, 16 are lowered to a predetermined level for engagement with the separating assembly 202; the apparatus 202 activates the driving system to move the separating assembly 202 forwardly and for the arms to pivot inwardly such that the expandable devices 68 are received in the cavity formed by the hub and rotor 14, 16 at the predetermined level; the apparatus 202 activates the expandable devices 68 thereby separating the hub and rotor until the rotor disengages and falls safely to the ground; and the apparatus 202 de-activates the driving system so that the arms pivot outwardly and retracts rearwardly into the dormant position allowing the apparatus 202 to perform other tasks.

The above method can also be performed manually but automating the process improves efficiency and safely by allowing the operator to be remote from the apparatus 202 during the operation.

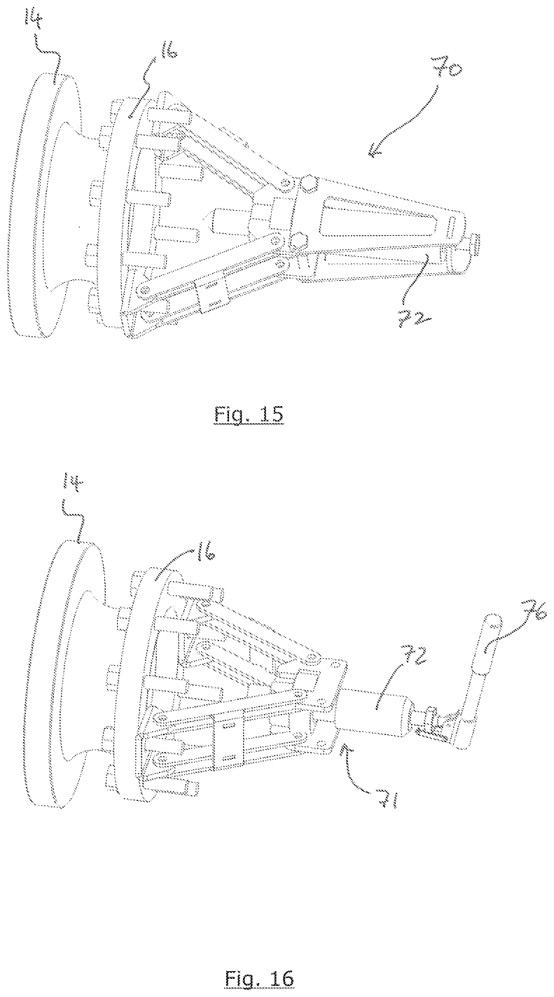

The hub and rotor assembly 14, 16 if the bearings are seized or the rotor 14 has seized to the axle can be removed by a puller 70, an example of which is illustrated in FIGS. 15 and 16. The puller 70 is attachable to spokes of the hub 16 and a hydraulically-powered cylinder 72 as shown in FIG. 15 can be used to apply the removal force of 20 tonnes by air supplied by a support trolley 66. Alternatively, as illustrated in the embodiment of FIG. 16, the puller 71 can apply 10 tonnes of removal force manually by pumping a handle 76 to pressurise the hydraulic cylinder 72.

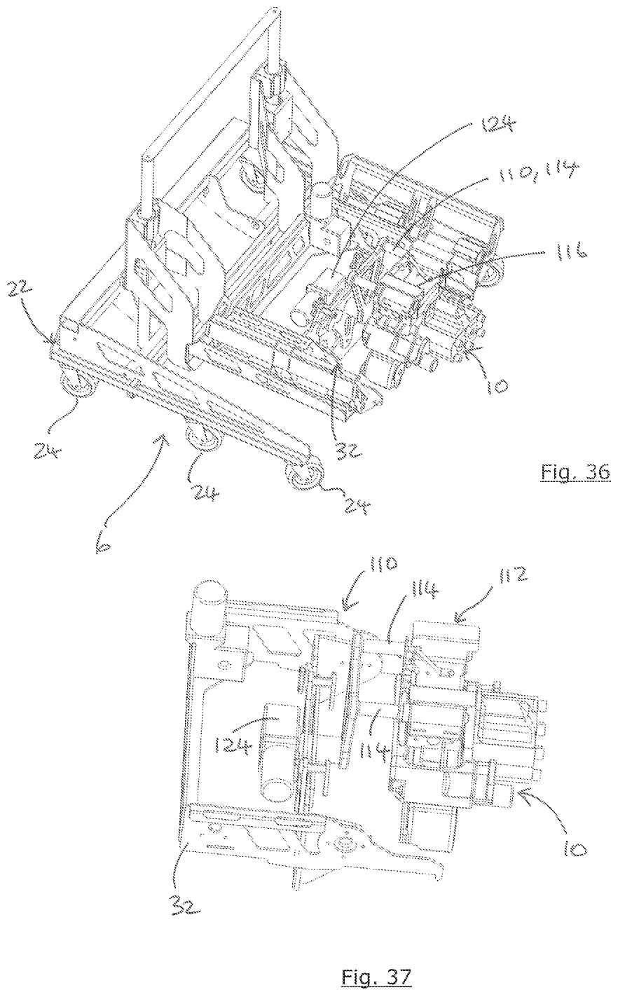

To facilitate removal of the caliper, the apparatus 4 can be configured to support a caliper 10 by means of the adaptor assembly 32 which includes a caliper mounting assembly 110 as illustrated in FIGS. 36 to 38. The caliper mounting assembly 110 is itself adapted to be engageable to a caliper engagement assembly 112 which is connectable to a caliper 10 when it is in an operative position on the heavy brake assembly. When the caliper mounting assembly 110 is engaged to the caliper engagement assembly 112 and the connected caliper 10, the apparatus 2 is able easily engageably support the caliper 10 and to secure it to the apparatus 4 to easily remove it from the vehicle for servicing and to position it in-situ for installation.

The caliper mounting assembly 110 can be in the form of a mounting head which has a pair of generally horizontal spaced-apart prongs 114 which are arranged to extend forwardly of an end portion of a radially extending arm 118 and mateably engage a pair of similarly spaced-apart sleeves 116 on the caliper engagement assembly 112. Advantageously, the spaced-apart dual point mounting arrangement provides a rigid engagement of the caliper 10 to the apparatus 4. A shaft 120 extends rearwardly from the other end portion of the radially extending arm 118 which is mateable with a correspondingly sized sleeve 122 on the adaptor plate 56 for engagement of the caliper mounting assembly 110 to the adaptor assembly 32.

The caliper engagement assembly 112 is advantageously configured to be able to removably attach to the caliper at whatever orientation on which it has rested to on the rotor 14 by means of the ability to rotate about a horizontal axis. As the rotor 14 can rotate, the in-situ caliper 10 can, under the influence of gravity, assume a natural position of balance such as at the upper or lower part of the rotor 14. The caliper engagement assembly 112 is thus rotatable about an axis, which is generally parallel to the axle, at an end portion of the radially extending arm 118 such that the caliper engagement member 112 and the engaged caliper 110 is movable in a circle about that axis. This allows the caliper engagement assembly 112 to be rotated to match the caliper orientation and engaged caliper engagement assembly 112 so as to be able to supportably engage the caliper 10, by means of the rigid mounting arrangement, easily with the apparatus 2.

The apparatus 4 can also manipulate the attached caliper mounting assembly 110 in any of three orthogonal directions relative to the base 22 via the positioning assembly as described above in relation to the hub and rotor assembly 14, 16 to facilitate correct alignment of the caliper 10 and apparatus 4 for easy removal and installation. Similarly, when installing the caliper 10, the engaged caliper 10 can be positioned and rotated to whatever desired rotated orientation to attach the caliper 10 to the in-situ rotor 14. The caliper mounting assembly 110 and caliper 10 if so held can be rotated manually or alternatively an electric motor 124 can be used to drive the rotation which can be electrically connected and controlled from a central control panel on the rear of the apparatus 4.

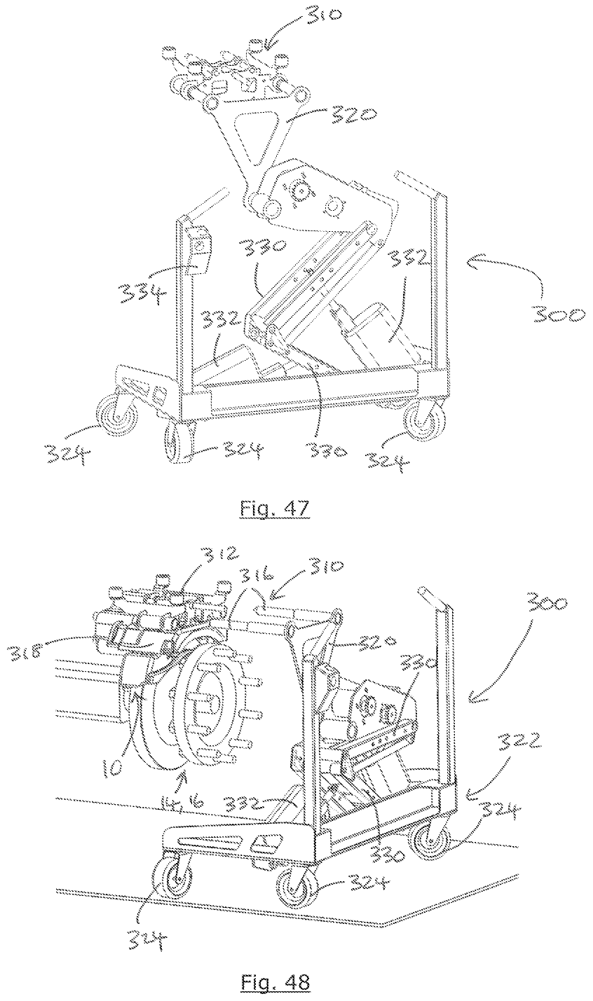

In an alternative embodiment of the present invention, there is also provided an apparatus 300 which is also configured to engage with and manipulate components of the heavy brake assembly and to position it relative to and away from the heavy brake assembly. In particular, FIGS. 47 to 52 which illustrates the apparatus 300 which is configured to remove and/or install a caliper 10 of a heavy brake assembly although it can be understood that other components of the heavy brake assembly could be similarly manipulated via various adaptor assemblies as described throughout this disclosure. This alternative embodiment advantageously allows the component, shown in this example as a caliper 10, which can be engaged with the apparatus 300 therefore allowing removal and installation onto an axis of a heavy vehicle, and which further allows deposition onto and removal from the ground (see FIG. 51). This avoids the need for a separate trolley or apparatus to hold the caliper 10 and given that multiple calipers 10 may be removed during a heavy vehicle brake maintenance process, this significantly reduces the need for specialised equipment. However if required a support trolley 302 which is configured for holding an engaged caliper may also be used.

As shown in FIGS. 48 to 51, the apparatus 300 includes a caliper mounting assembly 310 similar to the mounting assembly 110 described above. The caliper mounting assembly 310 is itself adapted to be engageable to a caliper engagement assembly 312 which is connectable to the caliper 10 when it is in an operative position on the heavy brake assembly. When the caliper mounting assembly 310 is engaged to the caliper engagement assembly 312 and the connected caliper 10, the apparatus 300 is able easily engageably support the caliper 10 and to secure it to the apparatus 300 to easily remove it from the vehicle for servicing and to position it in-situ for installation.

The caliper mounting assembly 310 can be in the form of a mounting head which has a pair of generally horizontal spaced-apart prongs 314 which are arranged to extend forwardly of an end portion of a radially extending arm 318 and mateably engage a pair of similarly spaced-apart sleeves 316 on the caliper engagement assembly 312. Advantageously, the spaced-apart dual point mounting arrangement provides a rigid engagement of the caliper 10 to the apparatus 300. The caliper engagement assembly 312 is advantageously configured to be able to removably attach to the caliper 10 at whatever orientation on which it has rested to on the rotor 14 by means of the ability to rotate about a horizontal axis. As the rotor 14 can rotate, the in-situ caliper 10 can, under the influence of gravity, assume a natural position of balance such as at the upper or lower part of the rotor 14.

The apparatus 300 is thus configured to operatively and adjustably control the rotation of the caliper engagement assembly 312 about an axis, which is generally parallel to the axle, at an end portion of the radially extending arm 320 such that the caliper engagement member 312 and the engaged caliper 10 is movable in a circle, in particular 3600 in either a clockwise or anti-clockwise direction) about that axis which is similar to that of the circumference of the rotor for ease of installation and removal. This allows the caliper engagement assembly 312 to be rotated to match the caliper orientation and engaged caliper engagement assembly 312 so as to be able to supportably engage the caliper 10, by means of the rigid mounting arrangement, easily with the apparatus 300.

The rotation of the caliper engagement assembly 312 can be driven by reduction means in the form of a reduction gear box which facilitates fine control of the rotational motion. The gear box can be driven electrically for ease of use, although manual means such as a crank handle may also be used.

The apparatus 300 can also manipulate the attached caliper mounting assembly 310 side-to-side and vertically and horizontally relative to the base 322 via a positioning assembly and in relation to the hub and rotor assembly 14, 16 to facilitate correct alignment of the caliper 10 and apparatus 300 for easy removal and installation. In particular the positioning assembly moves the component(s) held relative to the base of the apparatus 300 once the apparatus 300 has been initially positioned close to the heavy brake assembly via the wheels 324. The positioning assembly thus allows for movement, preferably fine movement, of the engagement assembly 312 and the component(s) so held for aligning the component easily with the axle or other parts of the heavy brake assembly which assists in removing and re-installing of the components. In this preferred embodiment, the positioning assembly can move the engagement assembly 312 (or other engagement/adaptor assemblies as described in this disclosure) in at least one or more directions relative to the axis of the axle of the heavy brake assembly, for example, i.e. raise and lower along a vertical axis and side-to-side in a lateral direction to the axle.

As illustrated in FIGS. 47 to 52, the positioning assembly includes a pair of linked support members 330 which are configured to be driven for movement in the vertical plane. One end of the lower linked support member 300 is connected pivotally to one side of the base of the apparatus 300 with the opposite end being pivotally connected to a lower end of the upper support member 330. The upper end of the linked support members 330 is associated with the caliper engagement assembly 312 but it can be understood that they could also be just as easily associated with other adaptor or engagement assemblies as described in this disclosure.

The linked support members 330 are movable to raise and lower the engaged caliper/component, and to be movable side-to-side by means of an actuating system. The actuating system comprises a pair of actuating members 332, such as linear actuators, although other actuating means such as hydraulic or pneumatic cylinders could be used. The lower ends of the actuating members 332 are pivotally connected to opposite ends of the base and are connected intermediate to ends of respective support members 330. The actuating members 332 are independently extendable to move the support members 330 and which allows movement in the vertical plane in any direction.

As most particularly illustrated in FIG. 47, the actuating members 332 are oriented to be angled upwardly from the base and substantially laterally to each other such that extension and retraction of the actuating members 332 will effect movement of the engaged caliper 10 vertically and laterally in a vertical plane. Notably, because of the angle of orientation of each actuating member 332, extending or retracting one such independent actuating member 332 will provide both a vertical motion and a respective lateral motion.

Thus to effect only horizontal motion of the engaged caliper 10, it is necessary to determine coordination of the actuating members 332. For example, for horizontal positioning of the engaged caliper 10 to the left, the left actuating member 332 retracts and the right actuating member 332 extends sufficiently in a way that produces only horizontal motion and any vertical motion is obviated. Similarly, for horizontal motion to the right, the left actuating member 332 extends and the right actuating member 332 retracts sufficiently in a way that produces only horizontal motion and any vertical motion is obviated. For only vertical raising and lowering, the left and right actuating members 332 extend or lower and in such a way that any horizontal motion is obviated.

It is the natural inclination of an operator to want to position an engaged component, such as the caliper 10, by using only vertical up-down or side-to-side motion. To assist this, the apparatus 300 can include a processor, and a control system having a control panel, whereby an operator operating the control panel via a joystick or other input means can indicate the intended motion of the engaged caliper 10, and the processor is able to determine the motion into the extension or retraction necessary of the two independent actuating members 332 so as to effect the intended motion.

Thus the system 2 allows for easy and efficient rigid engagement and removal of the caliper 10 of the heavy brake assembly without requiring heavy manual lifting, and in particular, avoids the awkward balancing and unbolting of the caliper 10, which reduces the risk of injury and further reduces costs and time to remove, service, and install heavy brake assemblies.

Alternatively, if the heavy brake is a drum brake type, after removal of the wheels 8 the apparatus 4 can be selectively configured to engage and hold a drum 12 while it is in-situ at the heavy vehicle and then remove it for repair and/or maintenance. The apparatus 4 can also manipulate the drum 12 in any of three orthogonal directions relative to the base 22 via the positioning assembly as described above to facilitate easy removal and installation. The apparatus 4 is also configured so as to be able to rotate the adaptor assembly 32, when held by the holding assembly, in a forward and backward direction such that the drum 12 can be rotated between an upright or vertical orientation where an axis of the drum 12 is generally horizontal (FIG. 23) and a horizontal orientation where the axis is generally vertical (FIG. 24). In the horizontal orientation, the held drum 12 can then lowered to the ground for storage and then the apparatus 4 can be used to remove another drum 12 from the heavy vehicle or be re-configured for removal or installation of another selected component. Alternatively the holding assembly can be lowered so as to be able to receive and engage a drum 12 and then raise the held drum 12 and move it to the heavy brake assembly for installation after rotating it to the vertical orientation.

The adaptor assembly 32 can include a drum cradle assembly which is configured to support a lower side of the bell of the drum 12 especially when the axis of the drum 12 is generally horizontal. This particularly assists in supporting the drum 12 during removal and installation of the drum 12 from the heavy vehicle as this is the orientation of the drum 12 when in operation. The drum cradle assembly can comprise a pair of curved support portions 78, each one of which is attachable to the adaptor plate 56.

The drum 12 can be supportably held by the adaptor assembly 32 by abutting the rear surface of the adaptor plate 56 to the rear of the drum 12 where the hub 16 typically is attached. The adaptor assembly 32 can have a pair of clamping members 62 which then affix the drum 12 such that the drum rear surface is forced against the adaptor plate 56. Preferably, the clamping members 62 are attachable to an inner surface underneath the lip edge of the drum 12. The clamping members 62 can preferably be the clamping members 62 which can used to fix the hub and rotor assembly or alternatively can be different clamping members.

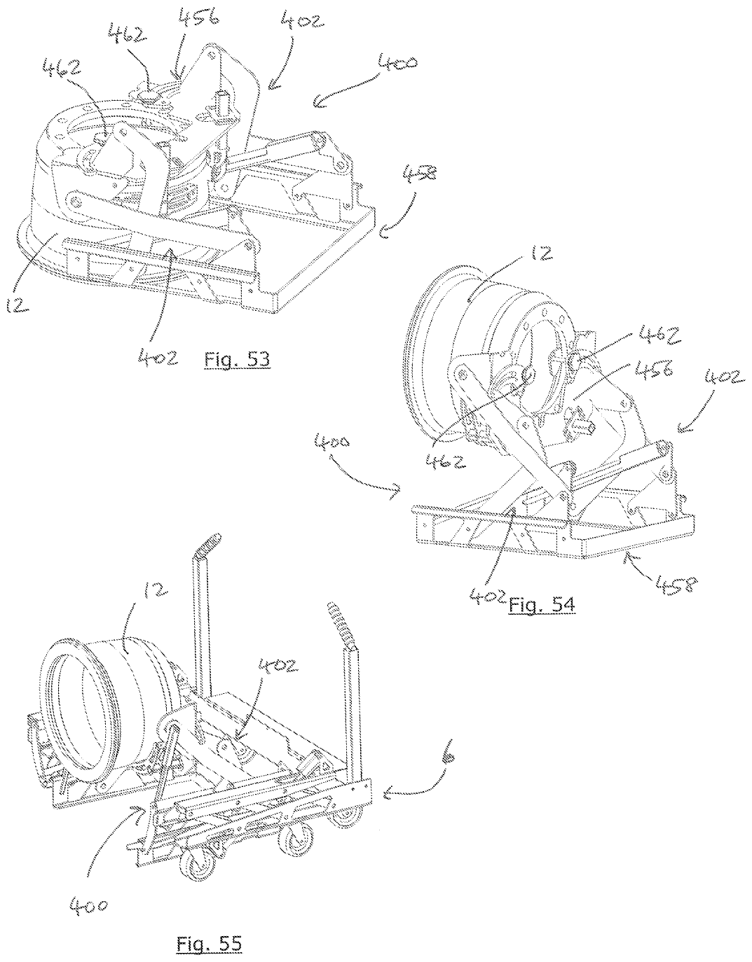

In FIGS. 53 to 55, there is shown an alternative adaptor assembly 400 which is configured to hold and support a drum 12. Similarly, the apparatus 6 is selectively configured to engage and hold a drum 12 by the adaptor assembly 400 while it is in-situ at the heavy vehicle and then remove it for repair and/or maintenance, similar to that of adaptor assembly 32 shown in FIGS. 23 and 24. The apparatus 6 can also manipulate the drum 12 in any of three orthogonal directions relative to the base 22 via the positioning assembly as described above to facilitate easy removal and installation. The adaptor assembly 400 is similar to the adaptor assembly 32 in being able to carry a drum 12 via the drum cradle assembly having curved support portions 478, support frame 458, adaptor plate 456, clamping members 462, being functionally similar to that of respective items 78, 58, 56 and 62 of FIGS. 23 and 24.

Specifically, in the adaptor assembly 400, the drum 12 is movably connected by pairs of arms 402 forming a linkage arrangement which extends between the drum cradle assembly and support frame 458. The linkage arrangement allows pivoting movement such that actuating members 404 can be connected to upper ends of the arms 402 so as to be able to raise and lower the drum 12 between the vertical and horizontal orientations of the axis as illustrated in FIGS. 53 and 54. In comparison, in the adaptor assembly 32, the drum pivots between arms of the support frame 58 itself. While the adaptor assembly 400 is shown carrying a drum 12, it would also be capable of being adapted to carry other components as discussed in relation to adaptor assembly 32.

While a detailed explanation has been provided to describe the removal of each part, such as the caliper or drum or wheels, it can also be understood by a person skilled in the art that more than one part can be removed at one time. For example, the hub and drum can be removed when so they attached together as the apparatus 2 is sufficient robust and strong enough to carry the two parts if necessary.

Alternatively the drum 12 can be selectably removed while still attached to the wheels 8 as shown in FIG. 28. This is advantageous as this avoids a further step of reconfiguring the apparatus 4, 6 for holding and/or removing the drum 12 if it does not require maintenance, repair or replacement. The use of electrical linear actuators is advantageous as it allows the apparatus 4 to carry an increased load in comparison to prior art devices which can only remove one component of the heavy brake assembly at a time due to load limitations.

As discussed above in relation to the hub and rotor assembly 14, 16 the adaptor plate 56 is pivotally attached to the support frame 58 and therefore allows the held drum 12 to be rotated relative thereto between upright and horizontal orientations as required. The pivoting of the adaptor plate 56 and thus any held drum 12 can be operated by the electric motor 60 which can be controlled remotely by from a central control panel on the apparatus or wirelessly away from the apparatus similarly to the held hub and rotor assembly 14, 16. Alternatively the adaptor plate 56 can be manually manipulated for rotation of the held drum 12.

After the drum 12 or caliper 10 and hub and rotor assemblies 14, 16 have been removed then the next step is removal of the stub axles 18 illustrated with references to FIGS. 17 to 19. The selected stub axle 18 can be held by a stub axle adaptor assembly 80 which is supported by the apparatus 4 via the adaptor assembly 32. Thus the apparatus 4 is also configurable to rotatably support or engageably hold the stub axle 18 while it is being positioned for removal from or installation to the heavy brake assembly. In particular, the stub axle adaptor assembly 80 which is attachable to the adaptor plate 56 by connectors, such as bolts or clamps 82, to the apertures, slots or notches 84 in the adaptor plate 56.

The stub axle adaptor assembly 80 is also configured to be able to engage or hold an accessible portion of the stub axle 18, typically an end portion thereof. When the stub axle 18 is held or supported by the stub axle adaptor assembly 80 the positioning assembly can be operated to manipulate the stub axle 18 in any of the three orthogonal directions as described above. Preferably, the stub axle adaptor assembly 80 has a stub axle holding portion 86 and a stub axle adaptor plate 88 which is attachably fixable to the adaptor plate 56. The stub axle holding portion 86 is rotatably connected to the stub axle adaptor plate 88 and can be rotatable by means of an electric motor 90 for easy removal of the stub axle 18. The electric motor 90 can be easily connected to a main control unit on the apparatus 4 so that rotation of the stub axle 18 can be operated remotely. Alternatively, the stub axle 18 can be rotated manually while being held by the stub axle adaptor assembly 80 if necessary. Once the stub axle 18 has been detached from the brake assembly the apparatus 4 and the held stub axle 18 can then be removed to store, repair or maintain the stub axle 18 and at a later stage then return the stub axle 18 or its replacement for re-installation.

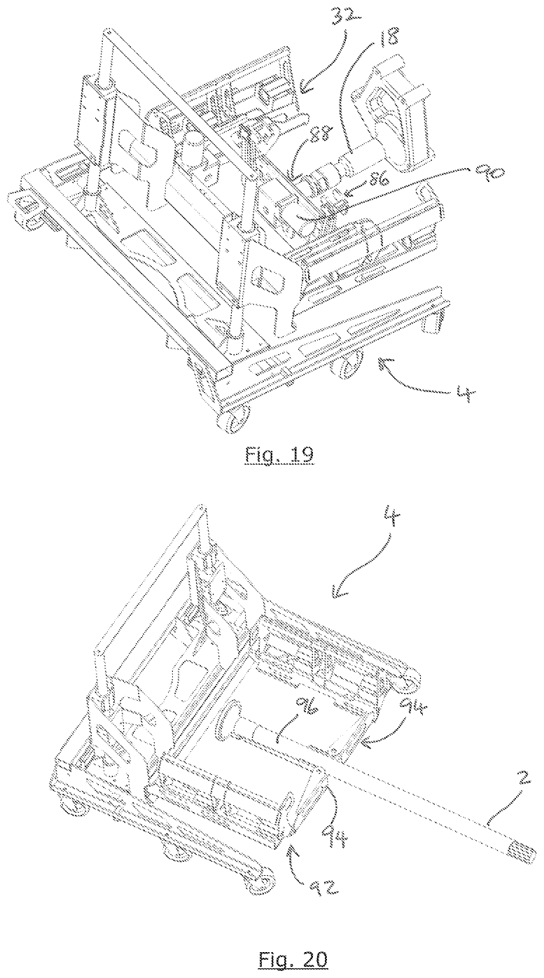

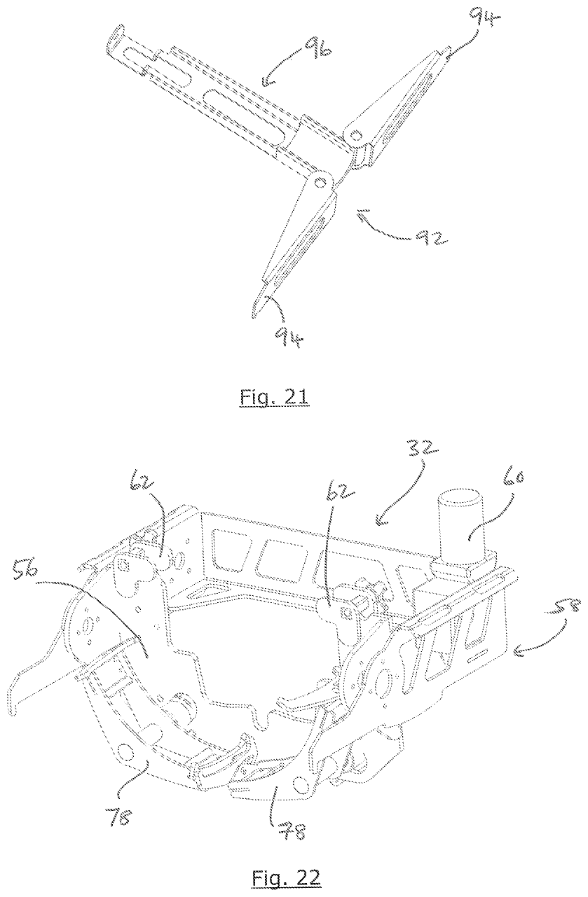

In a similar way the apparatus 4 can also be configurable to supportably engage or hold a drive axle 20 for removal and installation thereof as illustrated in FIGS. 20 and 21. The apparatus 4 can include a drive axle adaptor assembly 92 which is attachable to the ends of the horizontal portions 34. Thus the apparatus 4 is configurable to support or engageably hold the drive axle 20 while it is being positioned for removal from or installation to the heavy brake assembly. In particular, the drive axle adaptor assembly 92 can be attachable to the apparatus 4 by connectors, such as bolts or clamps.

The drive axle adaptor assembly 92 has a pair of oppositely directed wing members 94, the end portions of which are attachable to a front portion of the apparatus 4 and having a drive axle cradle portion 96 extending laterally therebetween for holding an outer accessible portion of the drive axle 20. When in operation, the wing members 94 can attach to the end portions of the horizontal portions 34 of the holding assembly and extend therebetween with the drive axle cradle portion 96 extending horizontally towards the rear of the apparatus 4 as illustrated particularly in FIG. 20. When the drive axle 20 is held or supported by the drive axle adaptor assembly 92 the positioning assembly can be operated to manipulate the drive axle 20 in any of the three orthogonal directions as described above for efficient and accurate removal or installation thereof. The end of the drive axle cradle portion 96 can be attachable to the end of the drive axle 20 by a fastener such as a pin which keeps the drive axle 20 fixed to the apparatus 4 during operation of the positioning assembly and also when the apparatus 4 is moved from one location to another as illustrated in FIGS. 20 and 21.

Removal of a stub axle 18 or a drive axle 20 is typically an awkward and inconvenient process due to its weight which is usually 80 to 100 kg for a heavy vehicle, and therefore involves associated health and safety risks. This is typically a two-person job with one person supporting the stub axle 18 and the other rotating or tightening or loosening depending on whether the stub or drive axle 18, 20 is being removed or installed. The apparatus 4 therefore allows a single person to remove and install a stub or drive axle with little or no effort 18, 20 and greatly reduces the injury risks to the maintenance technicians as well as allowing for faster and more efficient heavy vehicle brake maintenance and repair.

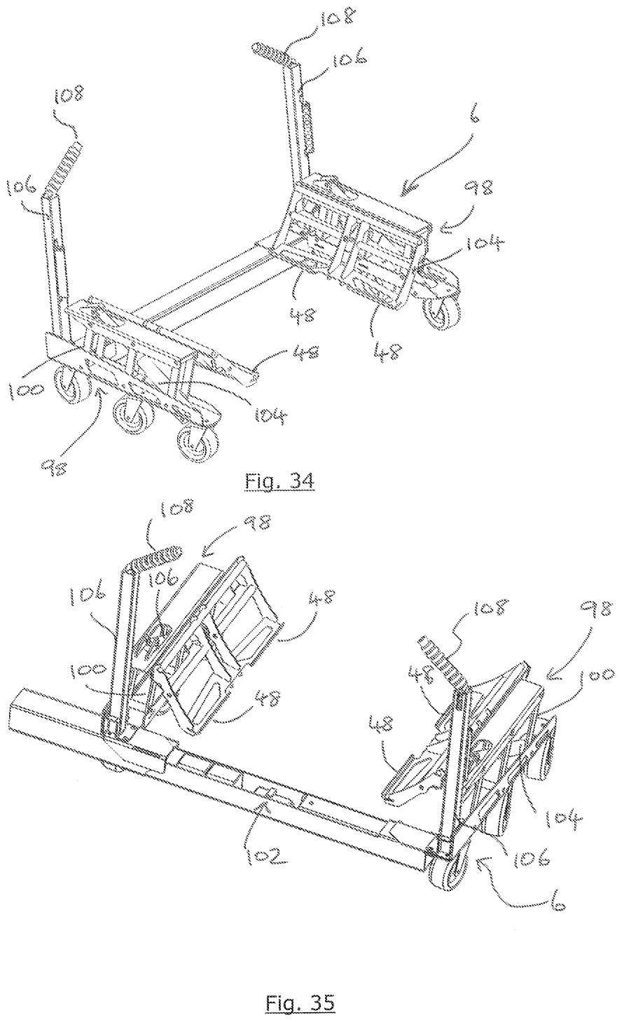

As illustrated in FIGS. 34 and 35, there is shown another preferred embodiment of an apparatus 6 for facilitating assembly and/or dis-assembly of a vehicle brake assembly. The apparatus 6 has a holding assembly for supportably holding a selected adaptor assembly and any held selected brake assembly part as described above which could be wheels, caliper, hub and rotor, drum, stub or drive axle. The apparatus 6 has a lifting assembly 98 for raising and lowering the holding assembly, the selected adaptor assembly and held selected brake assembly part. Notably, the apparatus 6 omits a positioning assembly for permitting controlled movement of the holding assembly, the selected adaptor assembly and held selected brake assembly part from side-to-side or forward and back movement, i.e. transverse horizontal movement to an axis of the axle or parallel movement to the axle axis.

In this embodiment, the lifting assembly 98 has a pair of lifting devices on opposing sides of the apparatus, each lifting device comprising at least one linked foldable support member 100 configured to be driven for movement in the vertical plane, an upper portion of the support member(s) associated with the holding assembly and a lower portion of the support member(s) associated with the apparatus 6 and wherein the foldable support member(s) 100 are extendable and retractable to raise and lower the holding assembly and selected adaptor assembly.

An enclosure at the rear of the apparatus 6 houses a main cylinder 102 which can drive a pair of hydraulic cylinders 104, each of which drives a respective lifting device. At either side of the rear of the apparatus 6 there is a pair of upright shafts 106, upper ends of which have handles 108 for facilitating manipulation of the apparatus 6. A base of the apparatus 6 is supported from the ground by rollers, for example a set of six caster wheels 24.

This apparatus 6 advantageously allows for supportably holding a selected adaptor assembly and selected vehicle assembly part and thus still allows for assembly and dis-assembly of the brake assembly but does not have the expense and bulk of the apparatus 4 also having a positioning assembly as described above.

In an exemplary method of use of the system 2 as described above, the apparatus 4, 6 and selected adaptor assemblies 32, 40, 78, 80, 92, 400 can be used to facilitate removal of all parts of the brake assembly 8, 10, 12, 13, 16, 18, 20 from the vehicle for inspection and servicing and then similarly used to replace or re-install the brake assemblies with reference to FIGS. 1 to 35. The applicant expects that the time taken to perform this method would be significantly reduced thereby shortening the usual time that the vehicle is out of commission, and further reduces the amount of storage required to house all the parts of the brake assembly while the maintenance is taking place.

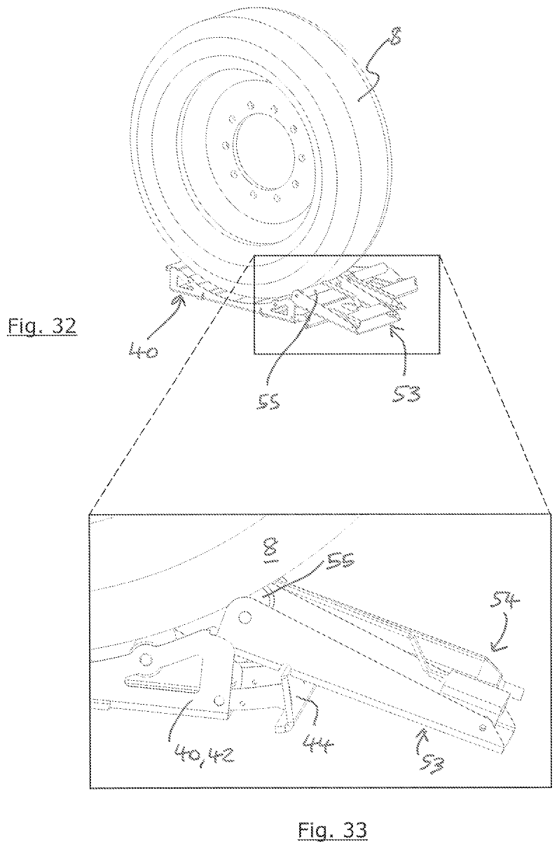

In a first step illustrated in FIGS. 29 to 33 the apparatus 4, 6 is moved to an empty rack 40 on the ground, the positioning assembly is lowered to pick the rack 40 directly off the ground and to position it under the heavy vehicle wheels 8. The dual set of wheels 8 is received onto the rollers of the rack 40 and arms 44 of the rack 40 clamp about the wheels 8 to keep them in the spaced-apart upright dual wheel configuration which advantageously maintains the alignment of the stud holes. The rack 40 with the received wheels 8 can then be removed to a storage location out of the service area and lowered directly onto the ground. Then the above steps can be repeated so as to remove all the wheels 8 from the brake assembly without effort or risk to the service technicians and where they can be kept safely in their upright configuration until inspection or re-installation. To inspect the entire rim of the wheels 8 the wheels 8 can be rotated on the rollers 52 manually on the rack 40 of FIGS. 29 and 30 or one of the wheels 8 can be pneumatically driven for ease of use as shown in FIGS. 32 and 33.

Once the wheels 8 have been removed, generally the next step is removal of the caliper 10 for dis-assembly of a disc brake assembly type as illustrated in FIGS. 36 to 38. First, to allow the apparatus 4 to grasp the caliper 10, the caliper engagement assembly 112 is attached to the caliper 10. The apparatus 4 is reconfigured to be able to supportably hold the caliper 10 by means of a caliper mounting assembly 110 which is attached to the adaptor assembly 32 via a sleeve and shaft arrangement 120, 122. The apparatus 4 is positioned such that it is proximal to the heavy brake assembly in particular that the forwardly directed prongs 114 of the mounting head are parallel to and towards the axle of the brake assembly.

Next the mounting head is rotated such that the prongs 114 are aligned with the sleeves 116 of the caliper engagement assembly 112 and either the apparatus 4 is movable forward on its wheels 24 or the positioning assembly is used to move the prongs 114 into engagement with the sleeves 116. The caliper engagement assembly 112 is then detached from the rotor 14 and the caliper 10, free from the brake assembly, is removable from the heavy vehicle out of the service area. The caliper 10 can be lowered to the ground for storage and detached from the apparatus 4, and the engagement assembly 112 can be removed for removal of a further caliper 10 or alternatively can be left attached for easy pick up.

In the next step, the hub and rotor adaptor assembly 32 of FIG. 11 is installed on the apparatus 4, 8 to remove the hub and rotor assembly 14, 16. Or to facilitate supporting the bell of the drum 12, the drum adaptor assembly comprising the hub and rotor adaptor assembly 32 and including the drum cradle assembly 78 attached to a lower portion of the hub and rotor adaptor assembly 14, 16.

Similarly to the wheels 8, if the heavy brake assembly is a drum brake type then the drum adaptor assembly is used to remove a drum 12 from one of the vehicle brake assembly by positioning the apparatus 4, 6 proximal to the brake assembly, supporting and holding the drum 12 with the selected adaptor assembly i.e. the drum adaptor assembly, removing the held drum 12 to a storage or maintenance area and rotating the drum 12 such that the axis of the drum 12 is vertical and to lower the drum 12 to the ground for storage and/or maintenance (see FIGS. 22 to 24). Then the above steps can be repeated so as to remove all the drums 12 from the brake assembly without effort or risk to the service technicians and where they can be kept safely in their upright stable configuration until inspection or re-installation.

Each of the hub and rotor assemblies 14, 16 of the heavy vehicle can also be removed by the same hub and rotor adaptor assembly 32, 400 in the same way as the drum 12 without the use of the drum cradle assembly as illustrated in FIGS. 8 to 12. The puller 70 of FIGS. 15 and 16 may be used on each brake assembly to remove the hub and rotor assembly 14, 16 from the vehicle should there be corrosion or warping which causes difficulties in removal.

If required, the hub and rotor assemblies 14, 16 can be first separated by use of the separating assembly 64 of FIGS. 13 and 14 which can often be seized together due to corrosion which can be promoted by the use of salt on icy roads. Thus each hub and rotor assembly 14, 16 can be easily separated as they are removed one by one from the heavy vehicle.

Once all the hub and rotor assemblies 14, 16 have been removed and placed into the storage area out of the service area, the drive axle adaptor assembly 92 can be installed on the hub and rotor adaptor assembly 32 and the apparatus 4, 6 can be positioned near to the drive axle 20 and so used to support the drive axle 20 while it is being unfixed from the heavy vehicle as shown in FIGS. 21 and 22. Then the drive axles 20 can be easily removed from the vehicle out of the service area one by one until they are all removed.

Lastly, the stub axle adaptor assembly 80 can replace the drive axle adaptor assembly 92 on the apparatus 4, 6, as shown in FIGS. 17 to 19. Then the apparatus 4, 6 can be positioned close to the heavy vehicle so as to facilitate removal of each stub axle 18. By rotating the stub axle 18 by use of the stub axle adaptor assembly 80 each stub axle 18 can be easily and quickly removed with little effort by a single person. Thus in this way all the stub axles 18 can be removed from the entire vehicle and out of the service area.

Further using the positioning assembly, controlled movement of the held parts, such as the wheels 8, calipers 10, hub and rotor 14, 16, drum 12, stub or drive axles 18, 20, in combination with the laser sighting system can be used to more quickly adjust fine positioning of the held parts for ease of removal and reinstallation. Thus the removal and installation does not require gross movement of the apparatus 4 itself by means of the wheels 24 or constant unaided alignment which depends heavily on the skill of the technician. Further, trying to initiate fine movement of the apparatus 4, 6 when heavily loaded on the wheels 24 can cause injuries when the load exceeds 350 kg therefore use of the positioning assembly greatly assists in reducing risk of injury.

All the separated brake assembly parts comprising the wheels 8, hub 16, rotors 14, calipers 10, drums 12, drive axles 20 and stub axles 18 can thus be easily and quickly removed by means of the above described method. By performing the above steps in a method which is generally the reverse of the disassembly procedure discussed above, the entire set of heavy brake assemblies of a heavy vehicle can be easily re-installed. It can be appreciated that the method describe above is a mere example and that the apparatus and system can be used in a variety of ways to facilitate removal and servicing of the brake assemblies.

Thus advantageously the removal and reinstallation of the entire brake assembly can be facilitated in a safe and beneficial way which reduces the risk of injury and number of technicians required. Previous methods or apparatus for removing the entire brake assembly only assist one or two steps by assisting removal of the drum or hub and rotor and therefore assistance in removing other parts of the brake assembly was lacking and still involved difficult manual handling at certain stages.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the assembly uppermost.

It will be appreciated by those skilled in the art that many modifications and variations may be made to the methods of the invention described herein without departing from the spirit and scope of the invention.

1. An apparatus for facilitating assembly and/or dis-assembly of a vehicle brake assembly, the apparatus being configured to be positionable relative to the brake assembly and movable away from the vehicle and further being configurable to support and hold a selected part of the vehicle brake assembly for facilitating removal and installation thereof, and wherein the apparatus comprises a positioning assembly configured to controllably move the selected held part of the brake assembly relative to a base of the apparatus, and the positioning assembly is further configured to raise and lower the held selected part between a lowered position where the selected part is in contact with or on the ground and a raised position where the selected part and adaptor assembly is transportable by the apparatus to or from the vehicle.

2. The apparatus according to claim 1, wherein the selected part is a brake drum or a hub and rotor assembly.

3. The apparatus according to claim 2, wherein the apparatus is configured to rotate the brake drum or a hub and rotor assembly from a position which facilitates removal and installation from the vehicle and to another position such that an exposed portion of the brake drum or a hub and rotor assembly faces the ground and to lower the brake drum or a hub and rotor assembly until the exposed portion is on or in contact with the ground.

4. The apparatus according to claim 1 wherein the positioning assembly is configured to controllably move the selected held part of the brake assembly in two transverse directions in a horizontal and/or a vertical plane for facilitating removal and installation.

5. The apparatus according to claim 1, wherein the positioning assembly has at least one actuating means for driving the controllable motion, wherein the actuating means is an electric linear actuator.

6. The apparatus according to claim 1, wherein the positioning of the positioning assembly has a sighting means for aiding a user to align the selected part when in an operative position relative to the vehicle for aiding removal and installation of the selected part.

7. The apparatus according to claim 1, further comprising a holding assembly configured to engage and hold a selected adaptor assembly, the selected adaptor assembly configured so as to be able to support and hold the selected part of the vehicle brake assembly, the holding assembly also being configured to dis-engage and hold the selected adaptor assembly and to engage and hold a further selected adaptor assembly which is configured to hold a further selected part different to the first, and wherein the holding assembly is configured to supportably hold either of the selected adaptor assemblies and respective held selected part for transport between an in-situ position and a removed position to facilitate removal and installation of the selected part or further part.

8. The apparatus according to claim 1, further comprising a holding assembly configured to engage and hold a selected adaptor assembly, the selected adaptor assembly configured so as to be able to support and hold a selected part of the vehicle brake assembly, the holding assembly also being configured to dis-engage and hold the selected adaptor assembly and to engage and hold a further selected adaptor assembly which is configured to hold a further selected part different to the first, and wherein the holding assembly is configured to supportably hold either of the selected adaptor assemblies and respective held selected part for transport between an in-situ position and a removed position to facilitate removal and installation of the selected part or further part.

9. The apparatus according to claim 1, wherein the selected part or parts include one or more of the following: hub, rotor, drum, caliper, wheel, stub axle and/or drive axle.

10. The apparatus according to claim 8, wherein the selected part is a brake drum or a hub and rotor assembly and the selected adaptor assembly is configurable to selectively hold a brake drum or hub and rotor assembly.

11. The apparatus according to claim 10, wherein when the drum and/or hub and rotor adaptor assembly is further configured to supportably hold and to pivot said brake drum or hub and rotor assembly and when so held, the brake drum or hub and rotor assembly is pivotable from an operative position where the held drum or hub and rotor assembly has a longitudinal axis which is generally horizontal to a transverse position wherein the axis is generally vertical.

12. The apparatus according to claim 11, wherein the configuration for selectively holding a brake drum includes attachment of a cradle assembly for supporting a bell of the drum.

13. The apparatus according to claim 12, wherein one of the selected parts is a caliper and the selected adaptor assembly is configured to support and carry a caliper.

14. The apparatus according to claim 13, wherein one of the selected parts is a vehicle wheel or a dual set of wheels and the selected adaptor assembly is a rack configured to carry an upright vehicle wheel or a dual set of spaced-apart upright wheels thereon.

15. The apparatus according to claim 14, wherein the rack has a pair of arms, each arm extending from opposite edges of the base which movable between a position where they clamp about the rim of the wheel for facilitating the upright configuration of the wheel and a position which facilitates rolling of the wheel(s) from the rack.

16. The apparatus according to claim 15, wherein the selected part is a stub axle or a drive axle and the selected adaptor assembly is a stub axle adaptor assembly or a drive axle adaptor assembly configured to supportably hold the stub axle or drive axle and wherein the stub axle or drive axle adaptor assembly is further configured to be removably attachable to the drum and/or hub and rotor adaptor assembly.

17. The apparatus according to claim 16, wherein the apparatus comprises a positioning assembly configured to controllably move the selected held part of the brake assembly relative to a base of the apparatus, and the positioning assembly is further configured to raise and lower the selected adaptor assembly and held selected part between a lowered position where the selected part is in contact with or on the ground and is dis-engageable from the corresponding adaptor assembly for storage and a raised position where the selected part and adaptor assembly is transportable by the apparatus to or from the vehicle.

18. An apparatus for facilitating assembly and/or dis-assembly of a vehicle brake assembly, the apparatus being configured to be positionable relative to the brake assembly and movable away from the vehicle and further being selectably configurable to support and hold an engaged hub and rotor assembly for facilitating removal and installation thereof, wherein the apparatus has a separating assembly having at least two expandable devices receivable in a cavity formed by the hub and rotor assembly, and when the separating assembly is so received, the expandable devices are drivable into an expandable configuration for forcible separation of the hub and rotor assembly.

19. The apparatus according to claim 1, further comprising at least one selectable adaptor assembly which is configurable to engage to support and hold a selected part or parts of the vehicle brake assembly for facilitating removal and installation thereof wherein the selected part or parts include one or more of the following: hub, rotor, drum, caliper, wheel, stub axle and/or drive axle; and any two or more afore-mentioned selected parts when so engaged.

20. The apparatus according to claim 19, wherein the selected part is a hub and rotor assembly and the selected adaptor assembly held by the apparatus is configured for holding a hub and rotor assembly and wherein the system includes a trolley having a separating assembly having at least two expandable devices receivable in a cavity formed by the hub and rotor assembly, and when the separating assembly is so received, the expandable devices are drivable into an expandable configuration for forcible separation of the hub and rotor assembly.
